(19) United States
(12) Patent Application Publication
(10) Pub. No.: US 2024/0373305 A1
(43) Pub. Date: Nov. 7, 2024

(54) METHODS AND DEVICES FOR PERFORMING MEASUREMENTS IN A NEW RADIO NETWORK

(71) Applicant: Telefonaktiebolaget LM Ericsson (publ), Stockholm (SE)

(72) Inventors: Zhixun Tang, Beijing (CN); Muhammad Ali Kazmi, Sundbyberg (SE); Joakim Axmon, Limhamn (SE)

(21) Appl. No.: 18/572,644

(22) PCT Filed: Jul. 11, 2022
(86) PCT No.: PCT/SE2022/050707

§ 371 Date: Dec. 20, 2023

(30) Foreign Application Priority Data
Aug. 6, 2021 (WO) PCT/CN2021/111361

(51) Int. Cl. H04W 36/00; H04W 36/08

(52) U.S. Cl. CPC H04W 36/0088; H04W 36/08

(57) ABSTRACT

A method performed in a User Equipment, UE, in a New Radio, NR, network, includes reporting to a network node, a capability indicating whether the UE supports Network Controlled Small Gap, NCSG, using a bit indicator together with Measurement Gap, MG patterns supported by the UE; or reporting, to the network node, NCSG patterns or one or more mandatory NCSG patterns using a number of bits; receiving a request message from the network node for performing a transformation from a current configured MG pattern to a corresponding NCSG pattern or from a current configured NCSG pattern to a corresponding MG pattern; determining parameters of the corresponding NCSG pattern or the MG pattern based on a mapping rule between MG patterns and NCSG patterns or from indication information received from the network node and switching to the corresponding NCSG pattern or the MG pattern for performing a measurement.

### TECHNICAL FIELD

The present disclosure generally relates to the technical field of wireless communications, and particularly to methods performed in a User Equipment (UE) and a network node for performing measurement, the UE and the network node.

### BACKGROUND

Measurement gap pattern (MGP) is used by the UE for performing measurements on cells of the non-serving carriers (e.g. inter-frequency carrier, inter-RAT carriers etc.). In New Radio (NR), gaps are also used for measurements on cells of the serving carrier in some scenarios e.g. if the measured signals (e.g. Synchronization signal and PBCH block, SSB) are outside the bandwidth part (BWP) of the serving cell. The UE is scheduled in the serving cell only within the BWP. During the gap the UE cannot be scheduled for receiving/transmitting signals in the serving cell. A measurement gap pattern (MGP) is characterized or defined by several parameters: measurement gap length (MGL), measurement gap repetition period (MGRP) and MG time offset wrt. reference time (e.g. slot offset wrt. serving cell's system frame number, SFN, such as SFN=0). An example of MGP is shown in FIG. 1. As an example MGL can be 1.5, 3, 3.5, 4, 5.5 or 6 ms, and MGRP can be 20, 40, 80 or 160 ms. Such type of MGP is configured by the network node and is also called as network controlled or network configurable MGP. Therefore the serving base station is fully aware of the timing of each gap within the MGP. FIG. 1 shows an example of the measurement gap pattern in New Radio.

In NR there are two major categories of MGPs: per-UE measurement gap patterns and per-Frequency Range (per-FR) measurement gap patterns. In NR the spectrum is divided into two frequency ranges namely FR1 and FR2. FR1 is currently defined from 410 MHz to 7125 MHz. FR2 range is currently defined from 24250 MHz to 52600 MHz. The FR2 range is also interchangeably called as millimeter wave (mmwave) and corresponding bands in FR2 are called as mmwave bands. In future more frequency ranges can be specified e.g. FR3. An example of FR3 is frequency ranging above 52600 MHz or between 52600 MHz and 71000 MHz or between 7125 MHz and 24250 MHz.

When configured with per-UE MGP, the UE creates gaps on all the serving cells (e.g. Primary Cell (PCell), Primary Secondary Cell (PSCell), Secondary Cell (SCells) etc.) regardless of their frequency range. The per-UE MGP can be used by the UE for performing measurements on cells of any carrier frequency belonging to any Radio access technology (RAT) or frequency range (FR). When the UE supports per-FR MGP and is configured with per-FR MGP, the UE creates gaps only on the serving cells of the indicated FR whose carriers are to be measured. For example, if the UE is configured with per-FR1 MGP, then the UE creates measurement gaps only on serving cells (e.g. PCell, PSCell, SCells etc.) of FR1 while no gaps are created on serving cells on carriers of FR2. The per-FR1 gaps can be used for measurement on cells of only FR1 carriers. Similarly, per-FR2 gaps when configured are only created on FR2 serving cells and can be used for measurement on cells of only FR2 carriers. Support for per FR gaps is a UE capability, i.e. certain UE may only support per UE gaps according to their capability.

Radio Resource Control (RRC) message for measurement gap configuration provided by network node to UE is shown below.

Information Element (IE) MeasGapConfig specifies the measurement gap configuration and controls setup/release of measurement gaps.

MeasGapConfig field descriptions

gapFR1
Indicates measurement gap configuration that applies to FR1 only. In (NG)EN-DC, gapFR1 cannot be set up by NR RRC
(i.e. only LTE RRC can configure FR1 measurement gap). In NE-DC, gapFR1 can only be set up by NR RRC (i.e. LTE RRC
cannot configure FR1 gap). In NR-DC, gapFR1 can only be set up in the measConfig associated with MCG. gapFR1 can not
be configured together with gapUE. The applicability of the FR1 measurement gap is according to Table 9.1.2-2 and Table
9.1.2-3 in TS 38.133 [14].
gapFR2
Indicates measurement gap configuration applies to FR2 only. In (NG)EN-DC or NE-DC, gapFR2 can only be set up by NR
RRC (i.e. LTE RRC cannot configure FR2 gap). In NR-DC, gapFR2 can only be set up in the measConfig associated with
MCG. gapFR2 cannot be configured together with gapUE. The applicability of the FR2 measurement gap is according to
Table 9.1.2-2 and Table 9.1.2-3 in TS 38.133 [14].
gapUE
Indicates measurement gap configuration that applies to all frequencies (FR1 and FR2). In (NG)EN-DC, gapUE cannot be
set up by NR RRC (i.e. only LTE RRC can configure per UE measurement gap). In NE-DC, gapUE can only be set up by NR
RRC (i.e. LTE RRC cannot configure per UE gap). In NR-DC, gapUE can only be set up in the measConfig associated with
MCG. If gapUE is configured, then neither gapFR1 nor gapFR2 can be configured. The applicability of the per UE
measurement gap is according to Table 9.1.2-2 and Table 9.1.2-3 in TS 38.133 [14].
gapOffset
Value gapOffset is the gap offset of the gap pattern with MGRP indicated in the field mgrp. The value range is from 0 to
mgrp-1.
mgl
Value mgl is the measurement gap length in ms of the measurement gap. The measurement gap length is according to in
Table 9.1.2-1 in TS 38.133 [14]. Value ms1dot5 corresponds to 1.5 ms, ms3 corresponds to 3 ms and so on. If mgl-r16 is
present, UE shall ignore the mgl (without suffix).
mgrp
Value mgrp is measurement gap repetition period in (ms) of the measurement gap. The measurement gap repetition period
is according to Table 9.1.2-1 in TS 38.133 [14].
mgta
Value mgta is the measurement gap timing advance in ms. The applicability of the measurement gap timing advance is
according to clause 9.1.2 of TS 38.133 [14]. Value ms0 corresponds to 0 ms, ms0dot25 corresponds to 0.25 ms and
ms0dot5 corresponds to 0.5 ms. For FR2, the network only configures 0 ms and 0.25 ms.
refFR2ServCelllAsyncCA
Indicates the FR2 serving cell identifier whose SFN and subframe is used for FR2 gap calculation for this gap pattern with
asynchronous CA involving FR2 carrier(s).
refServCellIndicator
Indicates the serving cell whose SFN and subframe are used for gap calculation for this gap pattern. Value pCell
corresponds to the PCell, pSCell corresponds to the PSCell, and mcg-FR2 corresponds to a serving cell on FR2 frequency in
MCG.

| Conditional | |
|---|---|
| Presence | Explanation |
| AsyncCA | This field is mandatory present when configuring FR2 |
| | gap pattern to UE in: |
| | (NG)EN-DC or NR SA with asynchronous CA involving |
| | FR2 carrier(s); |
| | NE-DC or NR-DC with asynchronous CA |
| | involving FR2 carrier(s), if the field |
| | refServCellIndicator is set to mcg-FR2. |
| | In case the gap pattern to UE in NE-DC and NR-DC |
| | is already configured and the serving cell used for |
| | the gap calculation corresponds to a serving cell |
| | on FR2 frequency in MCG, then the field is |
| | optionally present, need M. Otherwise, it is |
| | absent, Need R. |
| NEDCorNRDC | This field is mandatory present when configuring |
| | gap pattern to UE in NE-DC or NR-DC. In case |
| | the gap pattern to UE in NE-DC and NR-DC is already |
| | configured, then the field is absent, need M. |
| | Otherwise, it is absent. |
| PRS | This field is optionally present, Need R, when |
| | configuring gap pattern to UE for measurements of |
| | DL-PRS configured via LPP (TS 37.355 [49]). |
| | Otherwise, it is absent. |

In NR, UEs shall support the measurement gap patterns listed in Table 1 below based on the applicability. UE determines measurement gap timing based on gap offset configuration and measurement gap timing advance configuration provided by higher layer signaling as specified in TS 38.331 v17.2.0 and TS 36.331 v16.5.0.

TABLE 1
Gap Pattern Configurations as defined in TS 38.133 v17.2.0

| | Measurement | Measurement Gap |
|---|---|---|
| | Gap Length | Repetition Period |
| Gap Pattern Id | (MGL, ms) | (MGRP, ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 5.5 | 20 |
| 13 | 5.5 | 40 |
| 14 | 5.5 | 80 |
| 15 | 5.5 | 160 |
| 16 | 3.5 | 20 |
| 17 | 3.5 | 40 |
| 18 | 3.5 | 80 |
| 19 | 3.5 | 160 |
| 20 | 1.5 | 20 |
| 21 | 1.5 | 40 |
| 22 | 1.5 | 80 |
| 23 | 1.5 | 160 |
| 24 | 10 | 80 |
| 25 | 20 | 160 |

In legacy Long Term Evolution (LTE), Network Controlled Small Gap (NCSG) pattern for LTE was already defined. If the UE requires NCSG to prevent the interruption and UE is not configured with asynchronous Dual Connectivity (DC),
When UE is not configured with measurement gap, the Evolved UMTS Terrestrial Radio Access Network (E-UTRAN) can explicitly provide a single NCSG pattern with constant repetition period per UE.
When UE is configured with Gap Pattern index (ID) #0 on some of, but not all, serving carriers including Primary Carrier Component (PCC) and Secondary Carrier Component(s) (SCC), a single NCSG pattern with NCSG Pattern ID #0 in Table 8.1.2.1.2-1 in TS 38.133 v17.2.0 can be implicitly configured on the serving carrier(s), where measurement gap is not configured.
When UE is configured with Gap Pattern ID #1 on some of, but not all, serving carriers including PCC and SCC(s), a single NCSG pattern with NCSG Pattern ID #1 in Table 8.1.2.1.2-1 in TS 38.133 v17.2.0 can be implicitly configured on the serving carrier(s), where measurement gap is not configured.
When UE measurement gap is configured on all serving carriers including PCC and SCC(s), NCSG should not be configured.

As shown in FIG. 2a which illustrates a schematic diagram of an exemplary measurement gap and NCSG, subframes of serving carrier 1 from i+1 to i+6 are used as measurement gap. The NCSG can be implicitly configured on other serving carrier subframes from j+1 to j+6, where no measurement gap is configured.

If the UE requires NCSG to prevent the interruption and the UE supporting asynchronous DC is configured with PSCell which is asynchronous with PCell,
When there is no measurement gap configured among Master Cell Group (MCG) and Secondary Cell Group (SCG) cell subframes, the E-UTRAN can explicitly provide a single NCSG pattern with constant repetition period per serving carrier.
When Gap Pattern ID #0 is configured for UE on MCG (or SCG) and no measurement gap is configured on SCG (or MCG), a single NCSG pattern with NCSG Pattern ID #2 can be implicitly configured on SCG (or MCG).
When Gap Pattern ID #1 is configured for UE on MCG (or SCG) and no measurement gap is configured on SCG (or MCG), a single NCSG pattern with NCSG Pattern ID #3 can be implicitly configured on SCG (or MCG).

As shown in FIG. 2b which illustrates a schematic diagram of an exemplary measurement gap and NCSG for dual connectivity, one serving carrier subframes from i+1 to i+6 are used as measurement gap. The NCSG can be implicitly configured on other serving carrier subframes from j+1 to j+7, where no measurement gap is configured.

In LTE the UEs support those NCSG patterns listed in Table 2 below that are relevant to its measurement capabilities.

TABLE 2
NCSG Configurations supported by the UE

| | Visible | Measurement | Visible | Visible |
|---|---|---|---|---|
| | interruption | Length during | interruption | interruption |
| NCSG | length before | which there | length after | Repetition |
| Pattern | measurement | is no gap | measurement | Period |
| Id | (VIL1, ms) | (ML, ms) | (VIL2, ms) | (VIRP, ms) |
| 0 | 1 | 4 | DL: 1 | 40 |
| | | | UL: 2 | |
| 1 | 1 | 4 | DL: 1 | 80 |
| | | | UL: 2 | |
| 2 | 2 | 3 | 2 | 40 |
| 3 | 2 | 3 | 2 | 80 |

During the VIL1 and VIL2, the UE is not expected to transmit and receive any data. During ML, the UE is expected to transmit and receive data on the corresponding serving carrier(s).

As to NR NCSG and NCSG patterns, it has been agreed to define NCSG patterns in TS38.133 v17.2.0, but it is unclear which patterns will be defined and how to design and map NCSG patterns in NR.

### SUMMARY

To address at least one of the problems described above, the disclosure is provided which comprises signalling and configuration in a UE and in a network node for NCSG design and transformation.

When NCSG is introduced in NR, Network (NW) needs to know how to configure the NCSG patterns to UE. There is a chance to reuse the legacy Measurement Gap (MG) pattern as much as possible. However, NR NCSG cannot use the similar design as LTE which use ML=MGL−VIL1−VIL2 in synchronous network, and shorter ML for asynchronous network. The reason is that the UE needs to meet the same measurement accuracy in NCSG compared with legacy measurement gap. Due to SSB Measurement Timing Configuration (SMTC) structure, the NCSG gap pattern should guarantee the same measurement length with legacy measurement gap.

At the same time, to simplify the signalling, it's better to reuse the legacy gap pattern signalling to implicitly indicate the NCSG patterns as much as possible.

Hence, a method to design the NCSG patterns and mapping the NCSG patterns with legacy MG patterns is needed.

In one embodiment, one or more mapping tables may be defined based on one or more rules, which map or relate the legacy MG patterns with the NCSG patterns. In one example of embodiment, a 1-to-1 mapping table may be defined that maps the legacy MG pattern index or ID to the same index NCSG pattern or ID e.g. legacy MG pattern ID #0 corresponds to NCSG pattern ID #0, and so on. In another example of embodiment, a mapping table may be defined that maps or relates one or more parameters of legacy MG pattern (e.g. MGL) to one or more parameters (e.g. VIL1, VIL2 etc.) of the corresponding NCSG pattern by a relation or a function e.g. MGL/(VIl1+VIL2)>threshold.

In another embodiment, a method in a UE may use the mapping tables to report the capabilities to a network node (NW), indicating whether it supports NCSG together with the supported MG patterns. After that, the network node (NW) may search the mapping table between the legacy MG patterns with the NCSG patterns.

In another example when NW configures the measGapConfig, it may also configure the ML, VIL and VIRP for NCSG pattern to the UE. In another example, NW may explicitly indicate whether NCSG or legacy MG will be used.

In another embodiment, a method that UE may report the capabilities to indicate which NCSG pattern should be used e.g. recommended NCSG pattern.

In another embodiment, when NW configures the NCSG configuration, it may also configure the NCGS time advance (NGTA) to align the start timing of ML with effective measurement length. In another example the UE may use the legacy Measurement Gap Timing Advance (MGTA) also for NCSG pattern. In another example the UE may derive a common MGTA (C-GTA) for both legacy MG and NCSG patterns based on a rule when the UE is configured with both legacy MG and NCSG patterns.

Particularly, in one aspect of the disclosure, there is provided a method performed in a User Equipment, UE, in a New Radio, NR, network is disclosed. The method comprises reporting to a network node, a capability indicating whether the UE supports Network Controlled Small Gap, NCSG, using a bit indicator together with Measurement Gap, MG patterns supported by the UE; or reporting, to the network node, NCSG patterns supported by the UE or one or more mandatory NCSG patterns supported by the UE using a number of bits. The method further comprises receiving a request message from the network node for performing a transformation from a current configured MG pattern to a corresponding NCSG pattern or from a current configured NCSG pattern to a corresponding MG pattern. The method further comprises determining parameters of the corresponding NCSG pattern or the corresponding MG pattern based on a mapping rule between MG patterns and NCSG patterns or from indication information received from the network node, wherein the MG patterns of the mapping rule include the MG patterns supported by the UE and the NCSG patterns of the mapping rule include the NCSG patterns supported by the UE. The method further comprises switching to the corresponding NCSG pattern or the corresponding MG pattern for performing a measurement.

In an embodiment, the UE may receive the indication information from the network node for indicating which one of the MG patterns or which one of the NCSG patterns supported by the UE is to be used.

In an embodiment, the UE may receive, from the network node, the indication information comprising configuration information of the corresponding NCSG pattern or configuration information of the corresponding MG pattern.

In an embodiment, the switching may comprise switching to the corresponding NCSG pattern or the corresponding MG pattern within a transition time, ΔT, after the UE received the request message for transformation from the network node.

In an embodiment, the mapping rule may be defined to guarantee a Measurement Length, ML, of each NCSG pattern equal to an effective MGL of each corresponding MG pattern.

In an embodiment, the mapping rule may be defined by 1-to-1 mapping each NCSG pattern to each MG pattern with a same or corresponding gap index, and a Visible Interruption Repetition Period, VIRP, of each NCSG pattern may have a same value as a Measurement Gap Repetition Period, MGRP, of each MG pattern with the same or corresponding gap index.

In an embodiment, the mapping rule may be defined where the NCSG patterns supported by the UE are a subset of the MG patterns supported by the UE.

In an embodiment, the mapping rule may be defined by mapping one or more parameters of the MG pattern to one or more parameters of the corresponding NCSG pattern by a function.

In an embodiment, the function may be comprise MGL/(VIl1+VIL2)>threshold, where MGL represents a measurement gap length of the MG pattern, VIL1 represents a Visible interruption length, VIL, before measurement, and VIL2 represents a VIL after measurement which is different from VIL1 or the same as VIL1.

In an embodiment, the NCSG patterns supported by the UE may correspond to mandatory MG patterns in the MG patterns supported by the UE.

In an embodiment, the one or more mandatory NCSG patterns may be determined based on at least one of following criterions:
Mandatory NCSG patterns are the patterns with the same effective MGL as in mandatory MG patterns;
Mandatory NCSG patterns are the patterns with the same effective MGL as a sub-set of mandatory MG patterns;
Mandatory NCSG patterns are the patterns whose ML and (VIL1+VIL2) are related by a function; and
Mandatory NCSG patterns are the patterns that the MGL of MG pattern and (VIL1+VIL2) are related by a function.

In an embodiment, ML/(VIL1+VIL2)>threshold T1; or MGL/(VIL1+VIL2)>threshold T2.

In an embodiment, the UE may determine a NCSG timing advance, NGTA, to guarantee the ML in the NCSG pattern aligned with the effective MGL in MG pattern.

In an embodiment, the UE may determine a NCSG timing advance, NGTA, to guarantee the ML contain the SMTC window.

In an embodiment, the NGTA may be determined based on the NCSG pattern and Measurement Gap Timing Advance, MGTA, configured for the MG pattern.

In an embodiment, the UE may determine one common Timing Advance for both the NCSG pattern and the MG pattern based on a function of NGTA and MGTA when the UE is configured with both the NCSG pattern and the MG pattern and also with MGTA for the MG pattern and NGTA for the NCSG pattern.

In another aspect of the disclosure, there is provided a method performed in a network node in New Radio, NR, network, comprises receiving, from a UE, a capability information of the UE indicating whether the UE supports Network Controlled Small Gap, NCSG, using a bit indicator together with Measurement Gap, MG patterns supported by the UE; or reporting, to the network node, NCSG patterns supported by the UE or one or more mandatory NCSG patterns supported by the UE using a number of bits. The method further comprises transmitting a request message to a User Equipment, UE, for transforming from a current configured Measurement Gap, MG, pattern to a corresponding Network Controlled Small Gap, NCSG, pattern or for transforming from a current configured NCSG pattern to a corresponding MG pattern.

In an embodiment, the network node may send an indication information to the UE for indicating which one of the MG patterns or which one of the NCSG patterns supported by the UE is to be used.

In an embodiment, the network node may send, to the UE, an indication information comprising configuration information of the corresponding NCSG pattern or configuration information of the corresponding MG pattern, obtained from a mapping rule between MG patterns and NCSG patterns.

In an embodiment, the network node may determine transition time, ΔT, for the UE switching to the corresponding NCSG pattern or the corresponding legacy MG pattern, after transmitting the request message for the transformation to the UE.

In an embodiment, the network node may adapt scheduling of data to the UE after the determined transition time, ΔT.

In another aspect of the present disclosure, there is provided a User Equipment, UE, comprising, a processor; and a memory having stored thereon a computer program which, when executed on the processor, causes the processor to carry out the method according to any embodiment of the present disclosure.

In another aspect of the present disclosure, there is provided a network node, comprising, a processor; and a memory having stored thereon a computer program which, when executed on the processor, causes the processor to carry out the method according to any embodiment of the present disclosure.

In another aspect of the present disclosure, there is provided a non-transitory computer readable storage medium, having stored thereon a computer program which, when executed on at least one processor, causes the at least one processor to carry out the method according to any embodiment of the present disclosure.

According to the above embodiments, the UE may determine which NCSG pattern can be supported based on the NCSG pattern configuration and reports the NCSG capabilities to the NW.

According to the above embodiments, the NW may derive the NCSG pattern based on the reported legacy MG patterns and the 1-to-1 mapping rule. The 1-to-1 mapping rule is to guarantee ML equaling to the effective measurement length (MGL−2*switching time). Visible interruption Repetition Period (VIRP) may be 1-to-1 mapped to MGRP by the same gap ID.

When the NW configures the NCSG configuration, it may also configure NCSG Timing Advance(NGTA) to guarantee that the starting time of ML in NCSG is aligned with the starting time of effective measurement length (MGL−switching time) in legacy MG with MGTA.

One of the advantages of the invention is that legacy MG signalling can be reused as much as possible.

The NCSG patterns can be easily transformed from the legacy MG patterns or vice versa with no signaling overheads (e.g., based on pre-defined rules) or with minimal overheads (e.g., based on explicit request from the NW).

Furthermore, compared with the measurement accuracy in legacy MG, the proposed embodiments can guarantee the same accuracy for UE measurements with the same gap patterns index in NCSG. Therefore, with NCSG, the measurement performance same as with legacy MG pattern can be maintained.

### BRIEF DESCRIPTION OF THE DRAWINGS

The above and other objects, features, and advantages of the present disclosure will become apparent from the following descriptions on embodiments of the present disclosure with reference to the drawings, in which:

FIG. 1 shows a schematic diagram of an exemplary measurement gap pattern in NR;

FIG. 2a shows a schematic diagram of an exemplary measurement GAP and NCSG in LTE;

FIG. 2b shows a schematic diagram of an exemplary measurement GAP and NCSG for dual connectivity in LTE;

FIG. 3 shows a schematic flow chart of a method performed in a UE for performing measurement according to an embodiment of the present disclosure;

FIG. 4 shows a schematic flow chart of a method performed in a network node for performing measurement according to an embodiment of the present disclosure;

FIG. 5a-5b show schematic diagrams of exemplary measurement GAP and NCSG in NR according to embodiments of the present disclosure;

FIG. 6 shows a schematic diagram of an exemplary Measurement Gap according to an embodiment of the present disclosure;

FIGS. 7a-7b show schematic diagrams of exemplary MG and NCSG according to embodiments of the present disclosure;

FIG. 8 shows a schematic block diagram of a UE for performing measurement according to embodiments of the present disclosure;

FIG. 9 shows a schematic block diagram of a network node for performing measurement according to embodiments of the present disclosure;

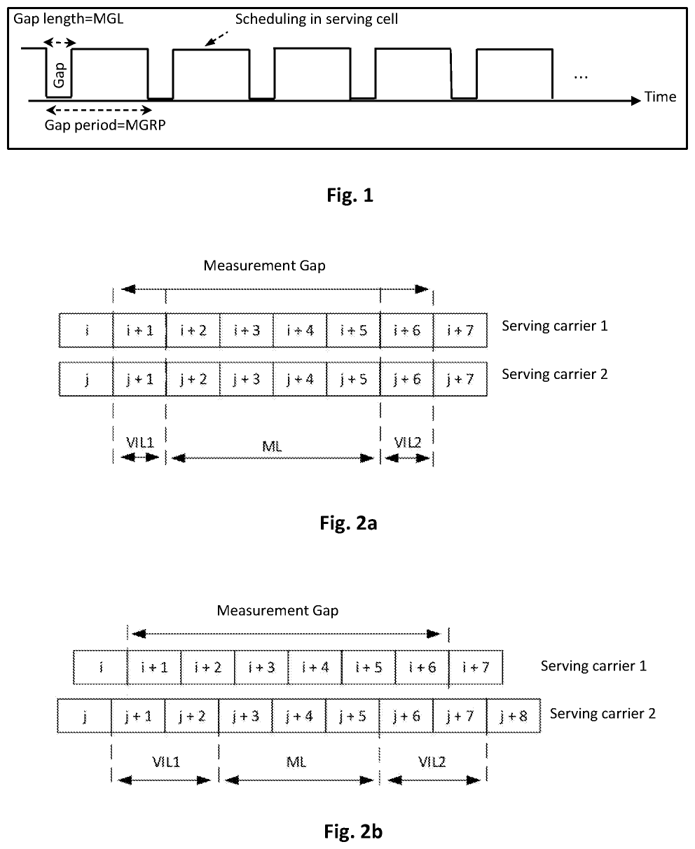

In the drawings, similar or same steps and/or elements are designated with similar or same referential numbers. It is to be noted that not all the steps and/or elements shown in the drawings are necessary for some embodiments of the present disclosure.

### DETAILED DESCRIPTION OF EMBODIMENTS

In the discussion that follows, specific details of particular embodiments of the present techniques are set forth for purposes of explanation and not limitation. It will be appreciated by those skilled in the art that other embodiments may be employed apart from these specific details. Furthermore, in some instances detailed descriptions of well-known methods, nodes, interfaces, circuits, and devices are omitted so as not obscure the description with unnecessary detail.

In this disclosure, a term “Node” is used which can be a network node or a user equipment (UE).

Examples of network nodes are NodeB, base station (BS), multi-standard radio (MSR) radio node such as MSR BS, eNodeB, gNodeB, MeNB, SeNB, Location Measurement Unit (LMU), Integrated Access Backhaul (IAB) node, network controller, Radio Network Controller (RNC), Base Station Controller (BSC), relay, donor node controlling relay, Base Transceiver Station (BTS), Central Unit (e.g. in a gNB), Distributed Unit (e.g. in a gNB), Baseband Unit, Centralized Baseband, Centralized RAN (C-RAN), Access Point (AP), transmission points, transmission nodes, Transmission Reception Point (TRP), Remote Radio Unit (RRU), Remote Radio Head (RRH), nodes in Distributed Antenna System (DAS), core network node (e.g. Mobile Switching Center (MSC), Mobile Management Entity (MME) etc.), Operation and Maintenance (O&M), Operation Support System (OSS), Self-Organized Network (SON), positioning node (e.g. Evolved Serving Mobile Location Centre (E-SMLC)),etc.

The non-limiting term UE refers to any type of wireless device communicating with a network node and/or with another UE in a cellular or mobile communication system. Examples of UE are target device, Device to Device (D2D) UE, Vehicular to Vehicular (V2V), machine type UE, Machine Type Communication (MTC) UE or UE capable of Machine to Machine (M2M) communication, Personal Digital Assistant (PDA), tablet, mobile terminals, smart phone, Laptop Embedded Equipment (LEE), Laptop Mounted Equipment (LME), Universal Serial Bus (USB) dongles etc.

The term radio access technology, or RAT, may refer to any RAT e.g. UTRA, E-UTRA, Narrow Band Internet of Things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of Downlink (DL) physical signals are Reference Signal (RS) such as Primary Synchronization Signal (PSS), Secondary Synchronization Signal (SSS), Channel State Information Reference Signal (CSI-RS), Demodulation Reference Signal (DMRS) signals in Synchronization Signal/Physical Broadcast Channel (SS/PBCH) block (SSB), Discovery Reference Signal (DRS), Cell Reference Signal (CRS), Positioning Reference Signal (PRS) etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset wrt. reference time (e.g. serving cell's SFN) etc. Therefore, SMTC occasion may also occur with certain periodicity e.g. 5 ms, 10 ms, 20 ms, 40 ms, 80 ms and 160 ms. Examples of Uplink (UL) physical signals are reference signal such as Sounding Reference Signal (SRS), DMRS etc. The term physical channel refers to any channel carrying higher layer information e.g. data, control etc. Examples of physical channels are PBCH, NPBCH, PDCCH, PDSCH, sPUCCH, sPDSCH, sPUSCH, MPDCCH, NPDCCH, NPDSCH, E-PDCCH, PUSCH, PUCCH, NPUSCH etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, etc.

Maximum operational timing difference (MOTD) is defined as timing difference experienced or which can be handled by the UE at the UE transmitter or UE receiver. MOTD is a generic term. Specific examples of MOTD are Maximum Receive Timing Difference (MRTD), Maximum Transmission Timing Difference (MTTD) etc. MRTD is the received time difference of signals received at the UE from two different serving cells. MTTD is the transmission time difference between signals transmitted by the UE from serving cells belonging to two different transmit timing management groups (TMG). Examples of TMG are primary Timing Advance Group (pTAG), secondary TAG (sTAG), primary secondary TAG (psTAG) etc. In each TMG, the UE maintains one common transmission timing for transmitting uplink signals from all serving cells belonging to that (the same) TMG.

Synchronous operation is also called as synchronized operation or synchronized network. In synchronous operation, a magnitude of an operational time difference between: a first signal (S1) from a first cell (cell1) and a second signal (S2) from a second cell (cell2), at the UE does not exceed MOTD. Examples of thresholds are MRTD, MTTD etc. For example MRTD is within ±33 μs. As a particular example the UE can operate using synchronized operation provided that the received time difference (MRTD) between the signals received at the UE from the subframe boundaries of the CCs belonging to different serving cells are within a certain threshold (e.g. MRTD) e.g. ±33 μs.

Asynchronous operation is also called as unsynchronized operation or unsynchronized network. The UE can operate in asynchronous network regardless of a magnitude of an operational time difference between S1 and S2 at the UE. For example the UE can operate in unsynchronized network even if the magnitude of MRTD is above 33 μs.

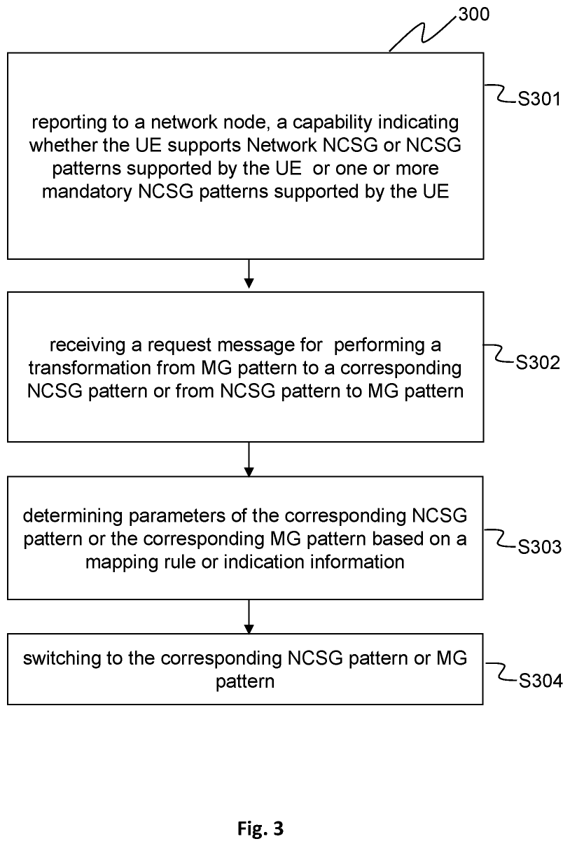

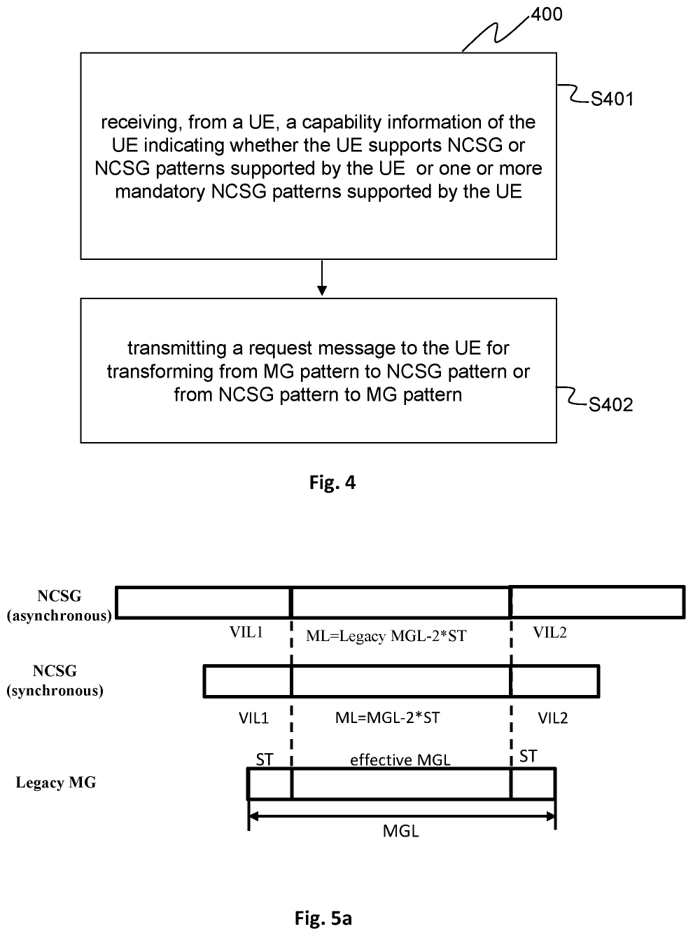

For the NCSG design and transformation in NR, the exemplary methods performed in the UE and network node for performing measurement using NCSG pattern or legacy MG pattern will be illustrated first, as shown in FIGS. 3 and 4.

FIG. 3 shows a schematic flow chart of a method 300 performed in a UE for performing measurement according to an embodiment of the present disclosure.

At step S301, the UE reports to a network node, a capability indicating whether the UE supports Network Controlled Small Gap, NCSG, using a bit indicator together with Measurement Gap, MG patterns supported by the UE; or the UE reports, to the network node, NCSG patterns supported by the UE or one or more mandatory NCSG patterns supported by the UE using a number of bits.

At Step S302, the UE receives a request message from the network node for performing a transformation from a current configured MG pattern to a corresponding NCSG pattern or from a current configured NCSG pattern to a corresponding MG pattern.

At Step S303, the UE determines parameters of the corresponding NCSG pattern or the corresponding MG pattern based on a mapping rule between MG patterns and NCSG patterns or from indication information received from the network node, wherein the MG patterns of the mapping rule include the MG patterns supported by the UE, and the NCSG patterns of the mapping rule include the NCSG patterns supported by the UE.

At Step S304, the UE switches to the corresponding NCSG pattern or the corresponding MG pattern for performing a measurement.

In an embodiment, the UE may receive the indication information from the network node for indicating which one of the MG patterns or which one of the NCSG patterns supported by the UE is to be used.

In an embodiment, the UE may receive, from the network node, the indication information comprising configuration information of the corresponding NCSG pattern or configuration information of the corresponding MG pattern.

In an embodiment, the switching may comprise switching to the corresponding NCSG pattern or the corresponding MG pattern within a transition time, ΔT, after the UE received the request message for transformation from the network node.

In an embodiment, the transition times for transforming from the MG pattern to the NCSG pattern and for transforming from the NCSG pattern to the MG pattern may be different or the same.

In an embodiment, the mapping rule may be defined to guarantee a Measurement Length, ML, of each NCSG pattern equal to an effective MGL of each corresponding MG pattern.

In an embodiment, the mapping rule may be defined by 1-to-1 mapping each NCSG pattern to each MG pattern with a same or corresponding gap index, and a Visible Interruption Repetition Period, VIRP, of each NCSG pattern may have a same value as a Measurement Gap Repetition Period, MGRP, of each MG pattern with the same or corresponding gap index.

In an embodiment, the mapping rule may be defined where the NCSG patterns supported by the UE are a subset of the MG patterns supported by the UE.

In an embodiment, the mapping rule may be defined by mapping one or more parameters of the MG pattern to one or more parameters of the corresponding NCSG pattern by a function.

In an embodiment, the function may be comprise MGL/(VIl1+VIL2)>threshold, where MGL represents a measurement gap length of the MG pattern, VIL1 represents a Visible interruption length, VIL, before measurement, and VIL2 represents a VIL after measurement which is different from VIL1 or the same as VIL1.

In an embodiment, the NCSG patterns supported by the UE may correspond to mandatory MG patterns in the MG patterns supported by the UE.

In an embodiment, the one or more mandatory NCSG patterns may be determined based on at least one of following criterions:
Mandatory NCSG patterns are the patterns with the same effective MGL as in mandatory MG patterns;
Mandatory NCSG patterns are the patterns with the same effective MGL as a sub-set of mandatory MG patterns;
Mandatory NCSG patterns are the patterns whose ML and (VIL1+VIL2) are related by a function; and
Mandatory NCSG patterns are the patterns that the MGL of MG pattern and (VIL1+VIL2) are related by a function.

In an embodiment, ML/(VIL1+VIL2)>threshold T1; or MGL/(VIL1+VIL2)>threshold T2.

In an embodiment, the UE may determine a NCSG timing advance, NGTA, to guarantee the ML in the NCSG pattern aligned with the effective MGL in MG pattern.

In an embodiment, the UE may determine a NCSG timing advance, NGTA, to guarantee the ML contain the SMTC window.

In an embodiment, the NGTA may be determined based on the NCSG pattern and Measurement Gap Timing Advance, MGTA, configured for the MG pattern.

In an embodiment, the UE may determine one common Timing Advance for both the NCSG pattern and the MG pattern based on a function of NGTA and MGTA when the UE is configured with both the NCSG pattern and the MG pattern and also with MGTA for the MG pattern and NGTA for the NCSG pattern.

In an embodiment, the effective MGL of the MG pattern equals to the MGL minus twice the switching time, wherein the switching time being used for UE switching from a carrier of a serving cell to a carrier of a measured cell.

In an embodiment, the UE performs a transformation from a current configured Measurement Gap, MG, pattern to a corresponding Network Controlled Small Gap, NCSG, pattern or from a current configured NCSG pattern to a corresponding MG pattern autonomously; the UE determines parameters of the corresponding NCSG pattern or the corresponding MG pattern based on a mapping rule between MG patterns and NCSG patterns or from indication information received from the network node; then the UE switches to the corresponding NCSG pattern or the corresponding MG pattern for measurement.

In an embodiment, the transition times for transforming from the MG pattern to the NCSG pattern and for transforming from the NCSG pattern to the MG pattern may be different or the same.

In an embodiment, the mapping rule may be defined to guarantee a Measurement Length, ML, of each NCSG pattern equal to an effective MGL of each corresponding MG pattern.

In an embodiment, the mapping rule may be defined by 1-to-1 mapping each NCSG pattern to each MG pattern with a same or corresponding gap index, and wherein a Visible Interruption Repetition Period, VIRP, of each NCSG pattern has a same value as a Measurement Gap Repetition Period, MGRP, of each MG pattern with the same or corresponding gap index.

In an embodiment, the mapping rule may be defined where the NCSG patterns supported by the UE are a subset of the MG patterns supported by the UE.

In an embodiment, the mapping rule may be defined by mapping one or more parameters of the MG pattern to one or more parameters of the corresponding NCSG pattern by a function.

In an embodiment, the function may comprise MGL/(VIl1+VIL2)>threshold, where MGL represents a measurement gap length of the MG pattern, VIL1 represents a Visible interruption length, VIL, before measurement, and VIL2 represents a VIL after measurement which is different from VIL1 or the same as VIL1.

In an embodiment, the NCSG patterns supported by the UE may correspond to mandatory MG patterns in the MG patterns supported by the UE.

In an embodiment, the UE may report, to the network node, one or more mandatory NCSG patterns supported by the UE.

In an embodiment, the one or more mandatory NCSG patterns may be determined based on at least one of following criterions:
Mandatory NCSG patterns are the patterns with the same effective MGL as in mandatory MG patterns;
Mandatory NCSG patterns are the patterns with the same effective MGL as a sub-set of mandatory MG patterns;
Mandatory NCSG patterns are the patterns whose ML and (VIL1+VIL2) are related by a function; and
Mandatory NCSG patterns are the patterns that the MGL of MG pattern and (VIL1+VIL2) are related by a function.

In an embodiment, ML/(VIL1+VIL2)>threshold T1; or MGL/(VIL1+VIL2)>threshold T2.

In an embodiment, the UE may determine a NCSG timing advance, NGTA, to guarantee the ML in the NCSG pattern aligned with the effective MGL in MG pattern.

In an embodiment, the UE may determine a NCSG timing advance, NGTA, to guarantee the ML contains the SMTC window.

In an embodiment, the NGTA may be determined based on the NCSG pattern and Measurement Gap Timing Advance, MGTA, configured for the MG pattern.

In an embodiment, the UE may determine one common Timing Advance for both the NCSG pattern and the MG pattern based on a function of NGTA and MGTA when the UE is configured with both the NCSG pattern and the MG pattern and also with MGTA for the MG pattern and NGTA for the NCSG pattern.

In an embodiment, the transforming may be performed autonomously from the MG pattern to the NCSG pattern when the UE is configured to measure only on carriers which are measured using the NCSG pattern, or the UE is deconfigured with the carriers which are only measured using the MG pattern.

In an embodiment, the transforming may be performed autonomously from the MG pattern to the NCSG pattern when the UE is configured to measure only on one or more serving carriers, or when the UE is deconfigured with one or more non-serving carriers.

In an embodiment, the transforming may be performed autonomously from the NCSG pattern to the MG pattern when the UE is configured to measure only on carriers which are measured using the MG pattern, or when the UE is deconfigured with the carriers which are only measured using NCSG pattern.

In an embodiment, the transforming may be performed autonomously from the NCSG pattern to the MG pattern at least when the UE is configured to measure on at least one carrier which needs MG pattern or when the UE is configured to measure on at least one non-serving.

FIG. 4 shows a schematic flow chart of a method 400 performed in a network node for performing measurement according to an embodiment of the present disclosure.

At Step S401, the network node receives, from the UE, a capability information of the UE indicating whether the UE supports Network Controlled Small Gap, NCSG, using a bit indicator together with Measurement Gap, MG patterns supported by the UE; or reporting, to the network node, NCSG patterns supported by the UE or one or more mandatory NCSG patterns supported by the UE using a number of bits.

At Step S402, the network node transmits a request message to a User Equipment, UE, for transforming from a current configured Measurement Gap, MG, pattern to a corresponding Network Controlled Small Gap, NCSG, pattern or for transforming from a current configured NCSG pattern to a corresponding MG pattern.

In an embodiment, the network node may send an indication information to the UE for indicating which one of the MG patterns or which one of the NCSG patterns supported by the UE is to be used.

In an embodiment, the network node may send, to the UE, an indication information comprising configuration information of the corresponding NCSG pattern or configuration information of the corresponding MG pattern, obtained from a mapping rule between MG patterns and NCSG patterns.

In an embodiment, the network node may determine transition time, ΔT, for switching to the corresponding NCSG pattern or the corresponding legacy MG pattern, after transmitting the request message for the transformation to the UE.

In an embodiment, the network node may adapt scheduling of data to the UE after the determined transition time, ΔT.

In an embodiment, the mapping rule may be defined to guarantee a Measurement Length, ML, of each NCSG pattern equal to an effective MGL of each corresponding MG pattern.

In an embodiment, the mapping rule may be defined by 1-to-1 mapping each NCSG pattern to each MG pattern with a same or corresponding gap index, and a Visible Interruption Repetition Period, VIRP, of each NCSG pattern has a same value as a Measurement Gap Repetition Period, MGRP, of each MG pattern with the same or corresponding gap index.

In an embodiment, the mapping rule may be defined where the NCSG patterns supported by the UE are a subset of the MG patterns supported by the UE.

In an embodiment, the mapping rule may be defined by mapping one or more parameters of the MG pattern to one or more parameters of the corresponding NCSG pattern by a function.

In an embodiment, the function may comprise MGL/(VIl1+VIL2)>threshold, where MGL represents a measurement gap length of the MG pattern, VIL1 represents a Visible interruption length, VIL, before measurement, and VIL2 represents a VIL after measurement which is different from VIL1 or the same as VIL1.

In an embodiment, the NCSG patterns supported by the UE may correspond to mandatory MG patterns in the MG patterns supported by the UE.

In an embodiment, the network node may determine one or more mandatory NCSG patterns to be supported by the UE.

In an embodiment, the one or more mandatory NCSG patterns may be determined based on at least one of following criterions:
Mandatory NCSG patterns are the patterns with the same effective MGL as in mandatory MG patterns;
Mandatory NCSG patterns are the patterns with the same effective MGL as a sub-set of mandatory MG patterns;
Mandatory NCSG patterns are the patterns whose ML and (VIL1+VIL2) are related by a function; and
Mandatory NCSG patterns are the patterns that the MGL of MG pattern and (VIL1+VIL2) are related by a function.

In an embodiment, ML/(VIL1+VIL2)>threshold T1; or MGL/(VIL1+VIL2)>threshold T2.

In an embodiment, the network node may determine a NCSG timing advance, NGTA, to guarantee the ML in the NCSG pattern aligned with the effective MGL in MG pattern.

In an embodiment, the network node may determine a NCSG timing advance, NGTA, to guarantee the ML contain the SMTC window.

In an embodiment, the NGTA may be determined based on the NCSG pattern and Measurement Gap Timing Advance, MGTA, configured for the MG pattern.

In an embodiment, the network node may determine one common Timing Advance for both the NCSG pattern and the MG pattern based on a function of NGTA and MGTA when the UE is configured with both the NCSG pattern and the MG pattern and also with MGTA for the MG pattern and NGTA for the NCSG pattern.

Hereinafter, a general description and detailed scenario for NCSG pattern design and mapping in NR will be described.

Generally, the UE is configured with at least a network controlled small gap (NCSG) pattern. Each of the NCSG patterns is characterized by a measurement length during which there is no gap (ML), visible interruption length before measurement (VIL1) and visible interruption length after measurement (VIL2), a visible interruption repetition period (VGRP), a gap offset (GO) relating the NCSG e.g. to the frame border of system frame number (SFN) 0, and a NCSG gap timing advance (NGTA) which may shift the position of the NCSG gap by 0, 0.25 or 0.5 ms relative to the NCSG starting point given by GO.

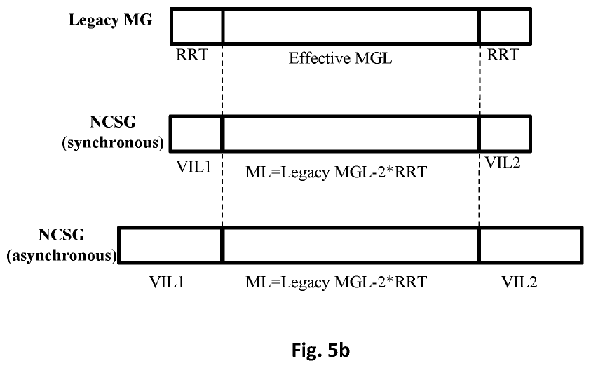

The general criteria to map NCSG pattern to legacy pattern is to guarantee that the ML equals to or corresponds to the effective measurement gap length (MGL) in legacy MGL. Switching time (ST) is 0.5 ms for frequency range FR1 and 0.25 ms for frequency range FR2. Effective MGL=MGL−2*ST. ST is also called as RF switching time, RF retuning time (RRT) etc. During the ST time, the UE retunes its transceiver between carriers e.g. between carriers of the serving cell and measured cell. FIG. 5a shows an exemplary measurement GAP and NCSG in NR where we can get the effective MGL in the legacy MG patterns as shown.

Here, some description is provided for the effective MGL. RF retuning time (RRT) depends on the FR according to TS 38.133 sections 9.2.1 and 9.3.1:
RRT=0.5 ms for FR1 and
RRT=0.25 ms for FR2

Therefore, ML should be:

$$ML = Legacy MGL - 1 ms for FR 1 and$$

$$ML = Legacy MGL - 0.5 ms for FR 2$$

VIL1 and VIL2 are at least equal to the RF tuning time. But in practice, VIL1/VIL2 may be longer e.g. considering same value for different SCS, interruption requirements etc. Also, for example, VIL1 and VIL2 depend on whether the NCSG is used in synchronous or asynchronous operation. For asynchronous case the VIL/2 is typically longer than that in synchronous case. The comparison between legacy MG pattern and NCSG in synchronous and asynchronous is illustrated in FIG. 5b.

Based on the legacy MG pattern table as shown in following Table 3 and the possible VIL values, we can derive the complete NCSG pattern table as follows. Legacy patterns #24 and #25 are used for positioning measurements. In one example these legacy patterns #24 and #25 may not apply to NCSG pattern. The complete set of NCSG patterns can be defined as elaborated below with several examples.

TABLE 3
Effective Measurement Length Pattern Configurations

| | | Measurement | Effective |
|---|---|---|---|
| | Measurement | Gap Repetition | measurement |
| Gap | Gap Length | Period | length |
| Pattern Id | (MGL, ms) | (MGRP, ms) | (ML, ms) |
| 0 | 6 | 40 | 5 |
| 1 | 6 | 80 | 5 |
| 2 | 3 | 40 | 2 |
| 3 | 3 | 80 | 2 |
| 4 | 6 | 20 | 5 |
| 5 | 6 | 160 | 5 |
| 6 | 4 | 20 | 3 |
| 7 | 4 | 40 | 3 |
| 8 | 4 | 80 | 3 |
| 9 | 4 | 160 | 3 |
| 10 | 3 | 20 | 2 |
| 11 | 3 | 160 | 2 |
| 12 | 5.5 | 20 | 5 |
| 13 | 5.5 | 40 | 5 |
| 14 | 5.5 | 80 | 5 |
| 15 | 5.5 | 160 | 5 |
| 16 | 3.5 | 20 | 3 |
| 17 | 3.5 | 40 | 3 |
| 18 | 3.5 | 80 | 3 |
| 19 | 3.5 | 160 | 3 |
| 20 | 1.5 | 20 | 1 |
| 21 | 1.5 | 40 | 1 |
| 22 | 1.5 | 80 | 1 |
| 23 | 1.5 | 160 | 1 |
| 24 | 10 | 80 | 9 |
| 25 | 20 | 160 | 19 |

### Embodiment #1: 1-to-1 Mapping to Legacy MG Pattern IDs

In one exemplary embodiment, the NCSG patterns can be 1-to-1 mapping to legacy MG patterns with the same gap ID. The mapping between NCSG patterns and the legacy MG patterns can be defined by a rule, which can be pre-defined or configured by the network. The 1-to-1 mapping may also be called as a lookup table or mapping table.

The 1-to-1 mapping rule is to guarantee that ML corresponds to the effective measurement length (MGL−2*switching time), e.g. switching time=0.5 ms for FR1 and 0.25 ms for FR2. VIRP of a NCSG pattern can have the same value as MGRP of a legacy MG pattern with the same gap ID. For example, thanks to the 1-to-1 mapping table the VIRP of NCSG pattern ID=0 is the same as the MGRP of the legacy MG pattern ID=0. During the ML, there is no gap meaning that during ML the UE can be scheduled with data in one or more serving cells.

When UE reports the capability for legacy measurement gap (MG) pattern by supportedGapPattern, the UE may also report 1 bit NCSG indicator on whether it supports the corresponding NCSG pattern or not.

After that, it's clear to both NW and UE which legacy MG patterns can be used for NCSG since NCSG pattern index can be 1-to-1 mapping to legacy MG pattern ID. An example of a mapping between legacy MG patterns and NCSG patterns for synchronous operation is shown in Table 4.

TABLE 4
NCSG Pattern Configurations (for synchronous operation)
and mapping to legacy MG pattern IDs

| | Parameters for NCSG patterns applicable in synchronous network operation | | | | |
|---|---|---|---|---|---|
| | | Visible | Measurement | | |
| | | interruption | Length | Visible | Visible |
| Legacy | | length | during | interruption | interruption |
| MG | NCSG | before | which there is | length after | Repetition |
| pattern | Pattern | measurement | no gap | measurement | Period |
| ID | Id | (VIL1, ms) | (ML, ms) | (VIL2, ms) | (VIRP, ms) |
| 0 | 0 | 1 | 5 | 1 | 40 |
| 1 | 1 | 1 | 5 | 1 | 80 |
| 2 | 2 | 1 | 2 | 1 | 40 |
| 3 | 3 | 1 | 2 | 1 | 80 |
| 4 | 4 | 1 | 5 | 1 | 20 |
| 5 | 5 | 1 | 5 | 1 | 160 |
| 6 | 6 | 1 | 3 | 1 | 20 |
| 7 | 7 | 1 | 3 | 1 | 40 |
| 8 | 8 | 1 | 3 | 1 | 80 |
| 9 | 9 | 1 | 3 | 1 | 160 |
| 10 | 10 | 1 | 2 | 1 | 20 |
| 11 | 11 | 1 | 2 | 1 | 160 |
| 12 | 12 | 0.75 | 5 | 0.75 | 20 |
| 13 | 13 | 0.75 | 5 | 0.75 | 40 |
| 14 | 14 | 0.75 | 5 | 0.75 | 80 |
| 15 | 15 | 0.75 | 5 | 0.75 | 160 |
| 16 | 16 | 0.75 | 3 | 0.75 | 20 |
| 17 | 17 | 0.75 | 3 | 0.75 | 40 |
| 18 | 18 | 0.75 | 3 | 0.75 | 80 |
| 19 | 19 | 0.75 | 3 | 0.75 | 160 |
| 20 | 20 | 0.75 | 1 | 0.75 | 20 |
| 21 | 21 | 0.75 | 1 | 0.75 | 40 |
| 22 | 22 | 0.75 | 1 | 0.75 | 80 |
| 23 | 23 | 0.75 | 1 | 0.75 | 160 |

The NCSG pattern for asynchronous network operation can also be defined. An example of a mapping between legacy MG patterns and NCSG patterns for asynchronous operation is shown in Table 5.

TABLE 5
NCSG Pattern Configurations (for asynchronous
operation) and mapping to legacy MG pattern IDs

| | Parameters for NCSG patterns applicable in asynchronous network operation | | | | |
|---|---|---|---|---|---|
| | | Visible | Measurement | Visible | Visible |
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| 0 | 0 | 2 | 5 | 2 | 40 |
| 1 | 1 | 2 | 5 | 2 | 80 |
| 2 | 2 | 2 | 2 | 2 | 40 |
| 3 | 3 | 2 | 2 | 2 | 80 |
| 4 | 4 | 2 | 5 | 2 | 20 |
| 5 | 5 | 2 | 5 | 2 | 160 |
| 6 | 6 | 2 | 3 | 2 | 20 |
| 7 | 7 | 2 | 3 | 2 | 40 |
| 8 | 8 | 2 | 3 | 2 | 80 |
| 9 | 9 | 2 | 3 | 2 | 160 |
| 10 | 10 | 2 | 2 | 2 | 20 |
| 11 | 11 | 2 | 2 | 2 | 160 |
| 12 | 12 | 0.75 | 5 | 0.75 | 20 |
| 13 | 13 | 0.75 | 5 | 0.75 | 40 |
| 14 | 14 | 0.75 | 5 | 0.75 | 80 |
| 15 | 15 | 0.75 | 5 | 0.75 | 160 |
| 16 | 16 | 0.75 | 3 | 0.75 | 20 |
| 17 | 17 | 0.75 | 3 | 0.75 | 40 |
| 18 | 18 | 0.75 | 3 | 0.75 | 80 |
| 19 | 19 | 0.75 | 3 | 0.75 | 160 |
| 20 | 20 | 0.75 | 1 | 0.75 | 20 |
| 21 | 21 | 0.75 | 1 | 0.75 | 40 |
| 22 | 22 | 0.75 | 1 | 0.75 | 80 |
| 23 | 23 | 0.75 | 1 | 0.75 | 160 |

Alternatively in another example, NCSG patterns for the synchronous and asynchronous network operations can be defined in the same table as shown in Table 6.

TABLE 6
NCSG Pattern Configurations for synchronous/asynchronous
operation and mapping to legacy MG pattern IDs

| | Parameters for NCSG patterns applicable in synchronous/asynchronous network | | | | |
|---|---|---|---|---|---|
| | operation | | | | |
| | | Visible | Measurement | Visible | Visible |
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| 0 | 0 | Sync: 1 | 5 | Sync: 1 | 40 |
| | | Async: 2 | | Async: 2 | |
| 1 | 1 | Sync: 1 | 5 | Sync: 1 | 80 |
| | | Async: 2 | | Async: 2 | |
| 2 | 2 | Sync: 1 | 2 | Sync: 1 | 40 |
| | | Async: 2 | | Async: 2 | |
| 3 | 3 | Sync: 1 | 2 | Sync: 1 | 80 |
| | | Async: 2 | | Async: 2 | |
| 4 | 4 | Sync: 1 | 5 | Sync: 1 | 20 |
| | | Async: 2 | | Async: 2 | |
| 5 | 5 | Sync: 1 | 5 | Sync: 1 | 160 |
| | | Async: 2 | | Async: 2 | |
| 6 | 6 | Sync: 1 | 3 | Sync: 1 | 20 |
| | | Async: 2 | | Async: 2 | |
| 7 | 7 | Sync: 1 | 3 | Sync: 1 | 40 |
| | | Async: 2 | | Async: 2 | |
| 8 | 8 | Sync: 1 | 3 | Sync: 1 | 80 |
| | | Async: 2 | | Async: 2 | |
| 9 | 9 | Sync: 1 | 3 | Sync: 1 | 160 |
| | | Async: 2 | | Async: 2 | |
| 10 | 10 | Sync: 1 | 2 | Sync: 1 | 20 |
| | | Async: 2 | | Async: 2 | |
| 11 | 11 | Sync: 1 | 2 | Sync: 1 | 160 |
| | | Async: 2 | | Async: 2 | |
| 12 | 12 | 0.75 | 5 | 0.75 | 20 |
| 13 | 13 | 0.75 | 5 | 0.75 | 40 |
| 14 | 14 | 0.75 | 5 | 0.75 | 80 |
| 15 | 15 | 0.75 | 5 | 0.75 | 160 |
| 16 | 16 | 0.75 | 3 | 0.75 | 20 |
| 17 | 17 | 0.75 | 3 | 0.75 | 40 |
| 18 | 18 | 0.75 | 3 | 0.75 | 80 |
| 19 | 19 | 0.75 | 3 | 0.75 | 160 |
| 20 | 20 | 0.75 | 1 | 0.75 | 20 |
| 21 | 21 | 0.75 | 1 | 0.75 | 40 |
| 22 | 22 | 0.75 | 1 | 0.75 | 80 |
| 23 | 23 | 0.75 | 1 | 0.75 | 160 |

Alternatively, in another example, as shown in Table 7, only the absolute values of VIL1 and VIL2 in NCSG patterns are defined without including the interruption time occurring due to the synchronous or asynchronous network operation. The interruption slots due to synchronous or asynchronous network operation can be explicitly defined in another table as shown in Table 8.

TABLE 7
NCSG Pattern Configurations without including interruption due to synchronous
or asynchronous network operation and mapping to legacy MG pattern IDs

| | Parameters for NCSG patterns applicable in synchronous/asynchronous network | | | | |
|---|---|---|---|---|---|
| | operation | | | | |
| | | Visible | Measurement | Visible | Visible |
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| 0 | 0 | 1 | 5 | 1 | 40 |
| 1 | 1 | 1 | 5 | 1 | 80 |
| 2 | 2 | 1 | 2 | 1 | 40 |
| 3 | 3 | 1 | 2 | 1 | 80 |
| 4 | 4 | 1 | 5 | 1 | 20 |
| 5 | 5 | 1 | 5 | 1 | 160 |
| 6 | 6 | 1 | 3 | 1 | 20 |
| 7 | 7 | 1 | 3 | 1 | 40 |
| 8 | 8 | 1 | 3 | 1 | 80 |
| 9 | 9 | 1 | 3 | 1 | 160 |
| 10 | 10 | 1 | 2 | 1 | 20 |
| 11 | 11 | 1 | 2 | 1 | 160 |
| 12 | 12 | 0.75 | 5 | 0.75 | 20 |
| 13 | 13 | 0.75 | 5 | 0.75 | 40 |
| 14 | 14 | 0.75 | 5 | 0.75 | 80 |
| 15 | 15 | 0.75 | 5 | 0.75 | 160 |
| 16 | 16 | 0.75 | 3 | 0.75 | 20 |
| 17 | 17 | 0.75 | 3 | 0.75 | 40 |
| 18 | 18 | 0.75 | 3 | 0.75 | 80 |
| 19 | 19 | 0.75 | 3 | 0.75 | 160 |
| 20 | 20 | 0.75 | 1 | 0.75 | 20 |
| 21 | 21 | 0.75 | 1 | 0.75 | 40 |
| 22 | 22 | 0.75 | 1 | 0.75 | 80 |
| 23 | 23 | 0.75 | 1 | 0.75 | 160 |

TABLE 8
Total number of interrupted slots on all serving cells

| | |
|---|---|
| NR SCS | Total number of interrupted slots on serving cells |

| (kHz) | synchronous | asynchronous |
|---|---|---|
| 15 | 1 | 2 |
| 30 | 1 | 2 |

| | |
|---|---|
| 60 | 3 |
| 120 | 5 |

### Embodiment #2: Subset to Legacy MG Patterns

Alternatively, in another example, NCSG patterns can be defined as a subset of legacy MG patterns. The main benefit from NCSG pattern is that data can be scheduled during the ML. In one example the following criteria may be applied for choosing the subset of the NCSG patterns.
1. MGL of legacy MG pattern and VIL1 and/or VIL2 of corresponding NCSG pattern (with same pattern ID e.g. ID=0) are related by a function. Examples of functions are average, ratio, sum, product etc. In one example MGL and VIL1 and/or VIL2 are related by a threshold (T). In one example VIL1 #VIL2. In another example VIL1=VIL2. Examples of functions relating MGL and VIL1 and/or VIL2 are:
   a. In one example the ratio of MGL/(VIL1+VIL2) shall be large than a threshold (T) e.g. MGL/(VIL1+VIL2)>T. For example, T=2.5.
   b. In another example the ratio of MGL/(2*VIL) shall be large than a threshold (T) e.g. MGL/(2*VIL)>T. For example, T=2.5.
   c. In one example the ratio of MGL/(VIL1+VIL2) shall be large than a threshold (T) e.g. MGL/(VIL1+VIL2)>T. Different threshold T can be applied In FR1 and FR2. For example, T=2.5 in FR1 and T=2 in FR2.
2. At least to support the same value as the effective MGL and MGRP as defined in legacy MG pattern, e.g., mandatory MG pattern configuration.

For example, using the above principles the NCSG pattern can be a subset of legacy MG pattern with effective MG as 5 ms as described below with examples.

### Example #1

Directly define the NCSG pattern as shown in Table 9. UE will report the supported NCSG gap pattern by signaling (e.g. new IE supportedNCSGPattern) using certain number of bits or bit map, e.g. 4-bit map. The leading/leftmost bit (bit 0) corresponds to the gap pattern 0, the next bit corresponds to the gap pattern 1, and so on. In this example, the MG pattern and NCSG pattern are related by the mapping Table 9, but the legacy MG pattern ID and the ID of the related or corresponding NCSG pattern are not the same.

TABLE 9
NCSG Pattern Configurations

| | Parameters for NCSG patterns applicable in synchronous/asynchronous network | | | | |
|---|---|---|---|---|---|
| | operation | | | | |
| | | Visible | Measurement | Visible | Visible |
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| FR1: 4, | 0 | FR1 Sync: 1 | 5 | FR1 Sync: 1 | 20 |
| FR2: 12 | | FR1 Async: 2 | | FR1 Async: 2 | |
| | | FR2: 0.75 | | FR2: 0.75 | |
| FR1: 0 | 1 | FR1 Sync: 1 | 5 | FR1 Sync: 1 | 40 |
| FR2: 13 | | FR1 Async: 2 | | FR1 Async: 2 | |
| | | FR2: 0.75 | | FR2: 0.75 | |
| FR1: 1 | 2 | FR1 Sync: 1 | 5 | FR1 Sync: 1 | 80 |
| FR2: 14 | | FR1 Async: 2 | | FR1 Async: 2 | |
| | | FR2: 0.75 | | FR2: 0.75 | |
| FR1: 5 | 3 | FR1 Sync: 1 | 5 | FR1 Sync: 1 | 160 |
| FR2: 15 | | FR1 Async: 2 | | FR1 Async: 2 | |
| | | FR2: 0.75 | | FR2: 0.75 | |

### Example #2

Define the NCSG pattern ID with the continuous pattern ID. When UE reports the capability for legacy measurement by supportedGapPattern, UE can also report 1-bit NCSG indicator on whether to support NCSG pattern or not. This example is shown in Table 10. In the example (Table 10), the NW based on received capability signalling can determine the NCSG pattern based on supported (effective MGL, MRGP) pair in legacy MG using the mapping Table 10. The value of ML=effective MGL and VIRP=MGRP in legacy MG. In this example as well the MG pattern and NCSG pattern are related by the mapping Table 10, but the legacy MG pattern ID and the ID of the related or corresponding NCSG pattern are not the same.

TABLE 10
NCSG Pattern Configurations

| | Parameters for NCSG patterns applicable in synchronous/asynchronous network | | | | |
|---|---|---|---|---|---|
| | operation | | | | |
| | | Visible | Measurement | Visible | Visible |
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| 0 | 0 | FR1 Sync: 1 | 5 | FR1 Sync: 1 | 40 |
| | | FR1 Async: 2 | | FR1 Async: 2 | |
| 1 | 1 | FR1 Sync: 1 | 5 | FR1 Sync: 1 | 80 |
| | | FR1 Async: 2 | | FR1 Async: 2 | |
| 4 | 2 | FR1 Sync: 1 | 5 | FR1 Sync: 1 | 20 |
| | | FR1 Async: 2 | | FR1 Async: 2 | |
| 5 | 3 | FR1 Sync: 1 | 5 | FR1 Sync: 1 | 160 |
| | | FR1 Async: 2 | | FR1 Async: 2 | |
| 12 | 4 | 0.75 | 5 | 0.75 | 20 |
| 13 | 5 | 0.75 | 5 | 0.75 | 40 |
| 14 | 6 | 0.75 | 5 | 0.75 | 80 |
| 15 | 7 | 0.75 | 5 | 0.75 | 160 |

### Example #3

Define the NCSG pattern ID with 1-to-1 mapping to legacy ID. Alternatively, in another example shown in Table 11, define the NCSG pattern ID same as legacy measurement gap ID as follows which is a non-continuous pattern ID. When UE reports the capability for legacy measurement by supportedGapPattern, UE can also report 1 bit NCSG indicator on whether to support NCSG pattern or not. After that, the NW can search the NCSG pattern ID based on supported legacy MG ID. It can clearly indicate which NCSG pattern will be supported by 1-to-1 mapping with legacy MG pattern.

TABLE 11
NCSG Pattern Configurations

| | | Visible | Measurement | Visible | Visible |
|---|---|---|---|---|---|
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| 0 | 0 | FR1 Sync: 1 | 5 | FR1 Sync: 1 | 40 |
| | | FR1 Async: 2 | | FR1 Async: 2 | |
| 1 | 1 | FR1 Sync: 1 | 5 | FR1 Sync: 1 | 80 |
| | | FR1 Async: 2 | | FR1 Async: 2 | |
| 4 | 4 | FR1 Sync: 1 | 5 | FR1 Sync: 1 | 20 |
| | | FR1 Async: 2 | | FR1 Async: 2 | |
| 5 | 5 | FR1 Sync: 1 | 5 | FR1 Sync: 1 | 160 |
| | | FR1 Async: 2 | | FR1 Async: 2 | |
| 12 | 12 | 0.75 | 5 | 0.75 | 20 |
| 13 | 13 | 0.75 | 5 | 0.75 | 40 |
| 14 | 14 | 0.75 | 5 | 0.75 | 80 |
| 15 | 15 | 0.75 | 5 | 0.75 | 160 |

### Example #4

Define the NCSG pattern ID same as mandatory measurement gap patterns e.g. as shown in Table 12.

TABLE 12
NCSG Pattern Configurations

| | | Visible | Measurement | Visible | Visible |
|---|---|---|---|---|---|
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| 0 | 0 | FR1 Sync: 1 | 5 | FR1 Sync: 1 | 40 |
| | | FR1 Async: 2 | | FR1 Async: 2 | |
| 1 | 1 | FR1 Sync: 1 | 5 | FR1 Sync: 1 | 80 |
| | | FR1 Async: 2 | | FR1 Async: 2 | |
| 13 | 2 | 0.75 | 5 | 0.75 | 40 |
| 14 | 3 | 0.75 | 5 | 0.75 | 80 |

### Example #5

Alternatively, the NCSG pattern can be defined as follows as shown in Table 13 and supported by UE. When UE reports to support NCSG, it should support the following patterns (both NCSG patterns) as in Table 13.

TABLE 13
NCSG Pattern Configurations

| | | Visible | Measurement | Visible | Visible |
|---|---|---|---|---|---|
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| FR1: 0, | 0 | FR1 Sync: 1 | 5 | FR1 Sync: 1 | 40 |
| FR2: 13 | | FR1 Async: 2 | | FR1 Async: 2 | |
| | | FR2: 0.75 | | FR2: 0.75 | |
| FR1: 1, | 1 | FR1 Sync: 1 | 5 | FR1 Sync: 1 | 80 |
| FR2: 14 | | FR1 Async: 2 | | FR1 Async: 2 | |
| | | FR2: 0.75 | | FR2: 0.75 | |

### Embodiment #3: Mandatory NCSG Pattern

In another embodiment, similar to mandatory legacy MG pattern, mandatory NCSG pattern can be defined based on certain criteria or rules, which will be described below. The UE is required to implement all the mandatory NCSG patterns. Otherwise without mandatory NCSG pattern, NW has to implement all the possible NCSG patterns because NW doesn't know which NCSG pattern will be supported for each UE. The one or more criteria or rules to define the mandatory NCSG pattern can be as follows.
Criterion/rule #1: Mandatory NCSG pattern is the pattern with the same effective MGL as in legacy mandatory MG patterns, for example, ML=5 ms and VIRP=40 ms or 80 ms.

The effective MGL of the corresponding legacy mandatory MG pattern (e.g. legacy MG ID=0) is also 5 ms.
Criterion/rule #2: Mandatory NCSG patterns are the patterns with the same effective MGL as a sub-set of mandatory MG patterns.
Criterion/rule #3: Mandatory NCSG pattern can be the pattern whose ML and VIL (assuming VIL1=VIL2) are related by a function and/or another parameter. In another example mandatory NCSG pattern can be the pattern whose ML, VIL1 and VIL2 are related by a function and/or another parameter. Examples of functions are ratio, maximum, minimum, average, sum, product etc. In one example the function of ML and VIL (or ML, VIL1 and VIL2) are related by a parameter e.g. threshold (T1) e.g.
   In one example the mandatory NCSG patterns meet the following condition or relation relating ML and, VIL1 and VIL2 with T1: ML/(VIL1+VIL2)>threshold T1, such as T1=2
   In another example the mandatory NCSG patterns meet the following condition or relation relating ML and VIL with T1: ML/(2*VIL)>threshold T1, such as T1=2
Criterion/rule #4: Mandatory NCSG pattern can be the pattern provided that the relation between or function of MGL of legacy MG pattern and VIL (assuming VIL1=VIL2) meets one or more conditions, or relation between or function of MGL of legacy MG pattern and, VIL1 and VIL2 meets one or more conditions. Examples of functions are ratio, maximum, minimum, average, sum, product etc. For example:
   In one example mandatory NCSG pattern can be the pattern with MGL/(2*VIL)>threshold T2, such as T1=2.5 when NCSG pattern can be 1-to-1 mapping to legacy MG pattern.
   In one example mandatory NCSG pattern can be the pattern with MGL/(VIL1+VIL2)>threshold T2, such as T1=2.5 when NCSG pattern can be 1-to-1 mapping to legacy MG pattern.

### Embodiment #4: NGTA for NCSG Pattern

In NR legacy MG, MGTA was introduced. For example, the MGTA enables the UE to retune its receiver before the start of the gap. This is particularly useful for smaller gaps and for shorter slot size e.g. 0.5 ms, 0.25 ms, 0.125 ms etc. The MG timing will be advanced by mgta to guarantee UE can perform measurement on SSBs within a complete SMTC.

Value MGTA is the measurement gap timing advance in ms. The applicability of the measurement gap timing advance is according to clause 9.1.2 of TS 38.133 [14]. Value ms0 corresponds to 0 ms, ms0dot25 corresponds to 0.25 ms and ms0dot5 corresponds to 0.5 ms. For FR2, the network only configures 0 ms and 0.25 ms.

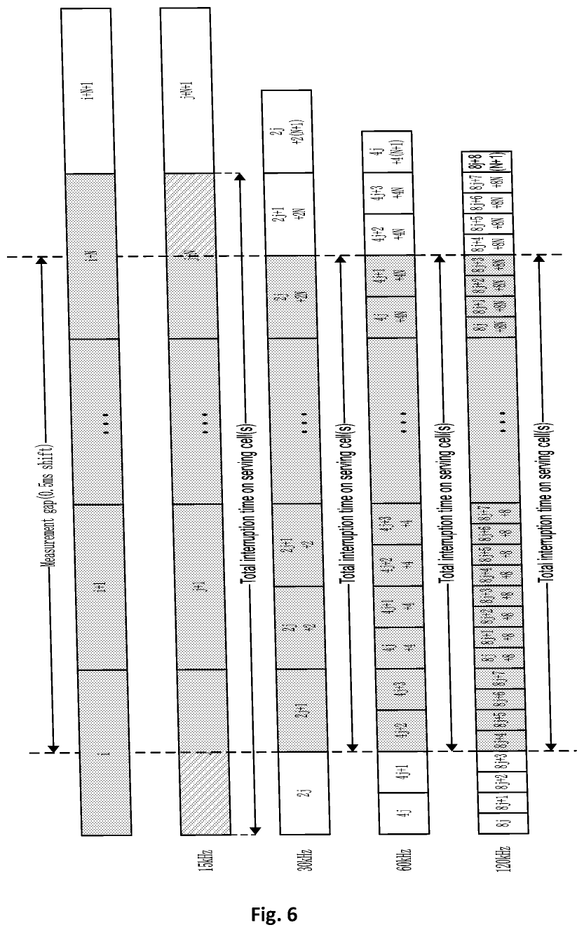

FIG. 6 shows a measurement gap with MGL=N(ms) with MG timing advance of 0.5 ms for all serving cells in synchronous EN-DC, NR standalone operation (with single carrier, NR Carrier Aggregation (CA) and synchronous NR-DC configuration) and synchronous NE-DC, and for serving cells in MCG in NR standalone operation (with asynchronous NR-DC configuration).

When NCSG patterns are introduced, it should also guarantee the SMTC window will be in the ML to meet the same measurement accuracy with legacy MG. Thus, a NGTA should be introduced to guarantee ML in NCSG pattern aligned with effective MGL in legacy MG pattern since VIL value is different with the switching time (ST) in legacy MG.

Value NGTA is the NCSG timing advance in ms. Value ms0 corresponds to 0 ms, ms0dot25 corresponds to 0.25 ms and ms0dot5 corresponds to 0.5 ms. For FR2, the network only configures 0 ms and 0.25 ms.

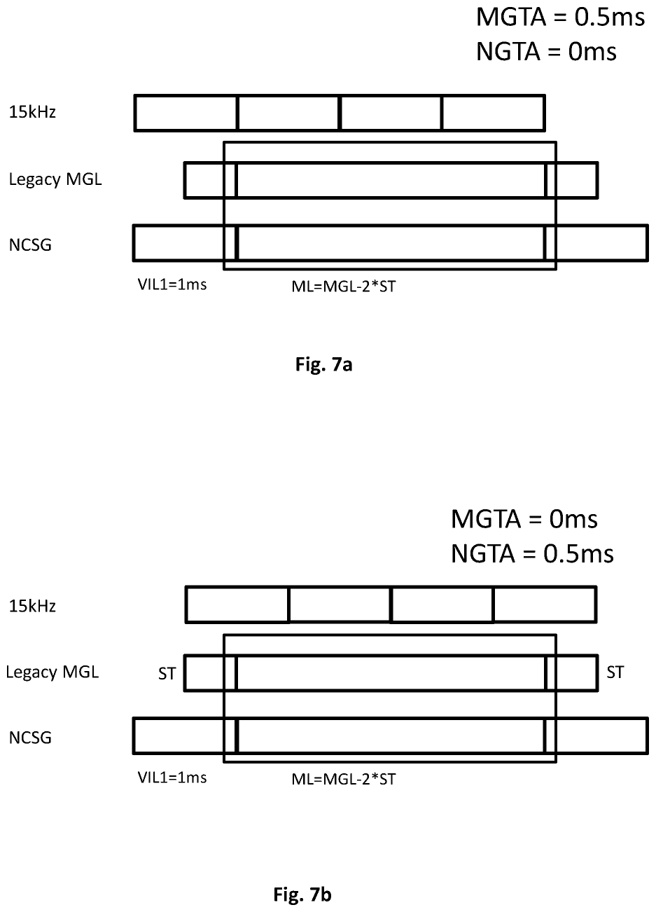

FIG. 7a shows a schematic diagram of an exemplary MG and NCSG according to an embodiment of the present disclosure, where ML=MGL−2*ST, VIL 1=1 ms, the MG with MGL=N (ms) with MG timing advance of 0.5 ms and NCSG with NCSG timing advance of Oms for all serving cells.

FIG. 7b shows a schematic diagram of an exemplary MG and NCSG according to an embodiment of the present disclosure, where ML=MGL−2*ST, VIL 1=1 ms, the MG with MGL=N (ms) with MG timing advance of Oms and NCSG with NCSG timing advance of 0.5 ms for all serving cells.

Alternatively, the UE can derive the NCSG timing based on NCSG configuration and MGTA configured for legacy MG without NGTA configuration. In one example, when the UE is configured with both NCSG and legacy MG patterns and with MGTA for legacy MG pattern, then the UE uses the same MGTA for both NCSG and legacy MG pattern. In another example, when the UE is configured with both NCSG and legacy MG patterns and also with MGTA for legacy MG pattern and NGTA for NCSG pattern, then the UE may derive one common TA (C-GTA) for both NCSG and legacy MG pattern based on a function of NGTA and MGTA. Examples of functions are ratio, maximum, minimum, average, sum, product etc.

The criterion is to guarantee the start timing of ML should be aligned with the effective MGL timing in legacy MGL. In the other words, the start timing of ML should equal to the start timing of MGL minus the switching time (ST).

### Embodiment #5: Transformation Between Legacy MG and NCSG Patterns

In another exemplary embodiment, the mapping rules may be defined for the UE and the NW for transforming between legacy MG pattern and corresponding NCGS pattern, e.g., thanks to the rules a legacy MG pattern can be transformed to NCSG pattern or vice versa. The transformation can be based on a rule, which can be pre-defined or configured by the network node. The transformation process may involve certain delay (ΔT), which may be called as the transformation time, transition time, conversion time etc. In one example, the transformation time (ΔT) may be the same for transforming from legacy MG pattern to NCSG pattern or from NCSG pattern to legacy MG pattern. In another example, the transformation time (ΔT) may be different for transforming from legacy MG pattern to NCSG pattern and for transforming to legacy MG pattern from NCSG pattern. Examples of transformation are given below:
For example based on a rule, the network node may request the UE (e.g. by sending indictor) to transform the currently configured legacy MG pattern to the corresponding NCSG pattern. The UE uses mapping between NCSG patterns and the legacy MG patterns, to determine the parameters (e.g. VIRP, VIL1/2, ML etc.) for the NCSG pattern and transforms the legacy MG pattern to NCSG pattern. Examples of mapping tables are the same as described in previous embodiments 1, 2 and 3 (e.g. examples in Tables 3-13). The UE then start using the NCSG pattern for further measurements. The UE starts using the transformed NCSG pattern no later than the transition time (ΔT1) after the moment (Tr1) the UE has received the request for transformation e.g. RRC message from the network node.
In another example the network node may also request the UE (e.g. by sending indictor) to transform the currently configured NCSG pattern to the corresponding legacy MG pattern. The UE also uses the mapping between NCSG patterns and the legacy MG patterns (e.g. using any of Tables 3-13), to determine the parameters (e.g. MGRP, MGL etc.) for the legacy MG pattern and transform the currently used NCSG pattern to the legacy MG pattern. The UE then starts using the legacy MG pattern for further measurements. The UE starts using the transformed legacy MG pattern no later than the transition time (ΔT2) after the moment (Tr2) the UE has received the request for transformation e.g. RRC message from the network node.
In another example the network node may also request the UE (e.g. by sending indictor) to transform the currently configured NCSG pattern to the corresponding legacy MG pattern. The UE also uses the mapping between NCSG patterns and the legacy MG patterns (e.g. using any of Tables 3-13), to determine the parameters (e.g. MGRP, MGL etc.) for the legacy MG pattern and transform the currently used NCSG pattern to the legacy MG pattern. The UE then starts using the legacy MG pattern for further measurements. The UE will stop the measurement by NCSG during the transition time (ΔT3) after the moment (Tr3) when one or more conditions or criteria are met. Examples of criteria is:
   When UE is requested to perform CA with the maximum carrier number which is reported by UE's capability.
In another example the UE may autonomously transform the currently configured legacy MG pattern to the corresponding NCSG pattern when one or more conditions or criteria are met. In this case as well the UE may perform transformation within transition time (ΔT1). Examples of criteria are:
   When UE is configured to measure only on certain types of carriers e.g. carriers of serving cells, carriers which do not require legacy MG pattern for measurements, carriers whose measured reference signals (e.g. SSBs) are within the bandwidth part of serving cells etc. Examples of serving cells are PCell, SCell and PSCell whose carriers are PCC, SCC and PSC respectively.
   When UE is deconfigured with some or all non-serving carriers e.g. inter-frequency carriers, inter-RAT carriers etc. For example, when UE deconfigures some non-serving carriers, the UE has a spare RF chain to perform NCSG measurements.
In another example the UE may autonomously transform the currently configured NCSG pattern to the corresponding legacy MG pattern when one or more conditions or criteria are met. In this case as well the UE may perform transformation within transition time (ΔT2). Examples of criteria are:
   When the UE is configured to measure on at least one carrier which needs legacy MG pattern e.g. inter-frequency carriers, inter-RAT carriers etc.
   When the UE is deconfigured to single carrier operation e.g. from CA or SC to single serving cell.
   When the UE is not configured to measure on carriers of certain serving cells e.g. not configured to measure on SCCs etc.

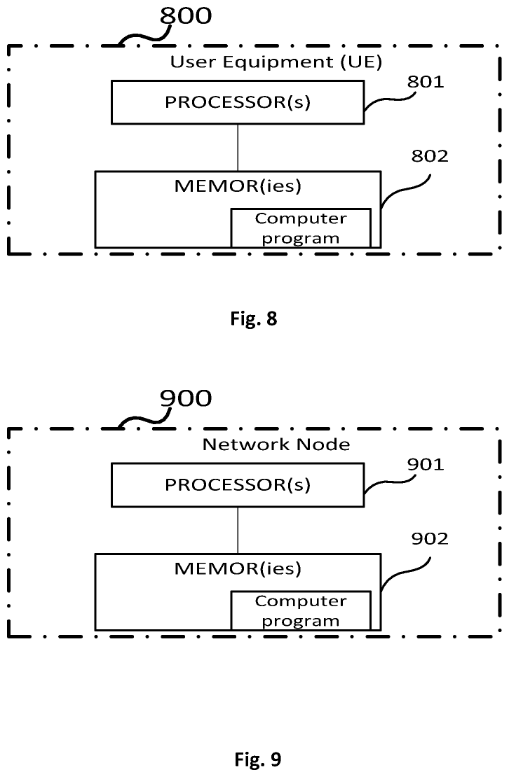

FIGS. 8-9 show schematic block diagrams of a UE 800 and a network node 900 for performing measurement according to embodiments of the present disclosure.

The UE 800 and the network node 900 each may include at least a processor 801, 901 and at least a memory 802, 902, as shown in FIGS. 8-9. As shown in FIG. 8, the memory 802 has stored thereon a computer program which, when executed on the processor 801, causes the processor 801 to carry out any of the methods performed in the UE 800 according to the present disclosure. As shown in FIG. 9, the memory 902 has stored thereon a computer program which, when executed on the processor 901, causes the processor 901 to carry out any of the methods performed in the network node 900 according to the present disclosure.

The memory may be, e.g., an Electrically Erasable Programmable Read-Only Memory (EEPROM), a flash memory and a hard drive. The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules could in alternative embodiments be distributed on different computer program products in the form of memories within the UE or the network nodes.

In an embodiment of the present disclosure, there is provided a computer-readable storage medium having stored thereon a computer program which, when executed on at least one processor of a UE, causes the at least one processor to carry out the UE methods according to the embodiments of the present disclosure.

In an embodiment of the present disclosure, there is provided a computer-readable storage medium having stored thereon a computer program which, when executed on at least one processor of a network node, causes the at least one processor to carry out the network node methods according to the embodiment of the present disclosure.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

A plurality of embodiments according to the present disclosure are further described as follows.

In principle, NCSG can be used for intra-frequency measurements with MG, inter-frequency measurements with MG, inter-RAT measurements. It is not determined yet on whether NW should configure the legacy MG rather than NCSG even UE can support both of them. Measuring deactivated SCC is one scenario for NCSG usage.

In NR typically the UE is configured with one or more SCC. To account for traffic load and/or UE power consumption the one or more SCells may often be in deactivation states. Therefore, the measurement on cells of the deactivated SCC is an important scenario for NCSG to avoid invisible interruptions on other serving cells. Therefore, NCSG should also be used for measurements on SCC with deactivated SCell.

In the following scenario, NCSG is used to avoid interruptions in NR. NR UE is typically configured with one or more SCCs and the one or more SCells may often be in deactivation states to account for traffic load and/or UE power consumption. It should be confirmed that the NCSG is also used for the measurements on the SCC with deactivated SCell.

Regarding the NCSG patterns for synchronous and asynchronous operation, TS38.133 v16.5.0 has defined that NCSG patterns being subset of the legacy MG patterns, however it is not defined on which subset of legacy MG patterns.

It is needed to define separate NCSG patterns for synchronous and asynchronous scenarios. There are several options on this issue:
Option 1: Different NCSG patterns for synchronous and asynchronous operations in FR1 and same NCSG patterns for synchronous and asynchronous operations in FR2.
Option 2: No need to separate NCSG patterns needed for synchronous and asynchronous operations.
Option 3: same NCSG patterns for synchronous and asynchronous operations, provided that the NCSG pattern only comprise the RF retuning time and ML. Interruption is not captured in VIL(RRT) and specified separately. There was an agreement that NCSG patterns will be specified for subset of the legacy MG patterns. One open issue is whether the same or different NCSG patterns will be defined for synchronous and asynchronous operations.

There is significant difference between interruption under synchronous and asynchronous operations in FR1. Therefore, it is not efficient to use the worst-case ML (for asynchronous) also for synchronous operation for the same NCSG patterns. Therefor he above option 1 is supported. Furthermore, it is suggested that NCSG patterns are defined for corresponding legacy gap patterns with ID #0, #1, #13 and #14. The reasoning is provided in the text below.

In short summary, it is observed that there is significant difference between interruption under synchronous and asynchronous operations in FR1. To avoid unnecessary interruption in synchronous operation it is more efficient to use NCSG pattern specific to synchronous operation in FR1.

Therefore, it is proposed that NCSG pattern depends on FR. To be specific, different NCSG patterns for synchronous and asynchronous operations in FR1 and same NCSG patterns for synchronous and asynchronous operations in FR2. It is also proposed to define selected NCSG patterns with larger MGL e.g. 5.5 ms-6 ms and define NCSG patterns for synchronous and asynchronous operations corresponding to legacy gap patterns with ID #0, #1, #13 and #14.

The gap pattern index for NCSG and VIL are not determined yet. However, there are several options on VIL:
Option 1a: VIL should be explicitly defined based on the number of interrupted durations in absolute time
Option 1b: VIL should be explicitly defined based on the number of interrupted duration in slot
Option 2: based on absolute RF retuning time (tentatively denoted as “RRT”).

There are also several options on ML of NCSG or the total length of NCSG):
Option 1: the total length of NCSG (“ML+VIL1+VIL2”) is same as MGL of the legacy gap
Option 2: the total length of NCSG (“ML+VIL1+VIL2”) is larger than MGL of the legacy gap and the effective measurement window of NCSG (which is equal to ML) is same as “legacy MGL−2*RRT)”.

Regarding VIL, it is agreed that VIL1/VIL2 are explicitly defined. The main difference is whether they should be in slots or in absolute time. The motivation of using slots is to define the VIL1/VIL2 based on SCS. There is no benefit of defining NCSG parameters based on SCS as it may unnecessarily complicate the UE and gNB implementation and lead to large number of NCSG patterns. Therefore VIL1/VIL2 are defined in absolute time e.g. in ms.

Regarding ML, one important principle for defining NCSG pattern is to ensure that the entire SMTC window is available during the ML of the NCSG for measurements. This will guarantee that the UE can perform the measurements and meet the measurement requirements like when they are performing using legacy measurement gaps.

Therefore option 2 is intended to be used, where RF retuning time (RRT) depends on the FR according to TS 38.133 sections 9.2.1 and 9.3.1:

$$RRT = 0.5 ms for FR 1 and$$

$$RRT = 0.25 ms for FR 2$$

Therefore, ML should be:

$$ML = Legacy MGL - 1 ms for FR 1 and$$

$$ML = Legacy MGL - 0.5 ms for FR 2$$

VIL1 and VIL2 are at least equal to the RF tuning time. But in practice, VIL1/VIL2 may be longer e.g. considering same value for different SCS, interruption requirements etc. Also, for example, VIL1 and VIL2 depends on whether the NCSG is used in synchronous or asynchronous operation. For asynchronous case the VIL/2 is typically longer than that in synchronous case. The comparison between legacy MG pattern and NCSG in synchronous and asynchronous is illustrated in FIG. 5b.

Based on the interruption requirements (table 14), the VIL1/VIl2 for asynchronous case will be one slot longer than those for synchronous case.

TABLE 14
Interruption length at transition between
active and non-active during DRX

Interruption length X (slots)

| μ | NR Slot length (ms) | Sync | Async |
|---|---|---|---|
| 0 | 1 | 1 | 2 |
| 1 | 0.5 | 1 | 2 |

| | | |
|---|---|---|
| 2 | 0.25 | 3 |
| 3 | 0.125 | 5 |

To reduce number of patterns we propose that VIL1 and VIL2 for FR1 and FR2 are defined agnostic to SCS. Furthermore, for FR2 only one value can be defined for synchronous and asynchronous cases. Therefore, VIL1 and VIL2 can be expressed as shown in table 15:

TABLE 15
Proposed values of VILI and VIL2 for FR1 and FR2

| | |
|---|---|
| VIL1 | VIL2 |

| FR | Sync | Async | Sync | Async |
|---|---|---|---|---|
| FR1 | 1 ms | 2 ms | 1 ms | 2 ms |

| | | |
|---|---|---|
| FR2 | 0.75 ms | 0.75 ms |

Another implication of VIL1/VIL2 for different scenarios is that the actual duration of the MGL in NCSG becomes longer than the MGL used in legacy gap pattern. It is suggested that NCSG patterns are defined only for legacy gaps with larger MGL e.g. 6 ms or 5.5 ms. At least NCSG corresponding to legacy patterns #0, #1, #13 and #14 are defined. These patterns are also mandatory from 3GPP Release-15.

It is also proposed that VIL1 and VIL2 for FR1 and FR2 are defined agnostic to SCS to limit the NCSG patterns and The VIL1/VIL2 for FR1 and FR2 are defined as follows:

| | |
|---|---|
| VIL1 | VIL2 |

| FR | Sync | Async | Sync | Async |
|---|---|---|---|---|
| FR1 | 1 ms | 2 ms | 1 ms | 2 ms |

| | | |
|---|---|---|
| FR2 | 0.75 ms | 0.75 ms |

The ML should be sufficiently long enough to contain SMTC window and the ML is defined as follows:

$$ML = Legacy MGL - 2 * RRT$$

$$Where : RRT = 0.5 ms for FR 1 and 0.25 ms for FR 2$$

It is not yet decided on explicit configuration for NCSG, but there are several options:
Option 1: NCSG configuration shall be based on legacy MG configuration
Option 1a: Introduce a single bit for existing MeasGapConfig to transform the legacy gap into NCSG.

The regular RRC configuration of NCSG pattern will be supported i.e. configuring all NCSG parameters. However, there are several scenarios in which it is beneficial to simply transform the currently configured legacy measurement gap pattern into NCSG pattern. For example if the UE is configured to measure on certain frequency layers which need legacy gaps then the UE will be configured with legacy gap pattern. But if the frequency layers which need legacy gaps are deconfigured then network may prefer to quickly switch to NCSG with the same parameters (e.g. MGRP, MGL etc) as used by the legacy pattern. Therefore, mapping between legacy measurement gaps and NCSG should be defined. This will enable the network to quickly transform the legacy measurement gap pattern to NCSG pattern or vice versa by simply sending an indicator e.g. using 1-bit.

One example of the mapping between legacy measurement gap patterns and NCSG pattern for all NCSG patterns is shown in table 16. This table gives one-to-one mapping between the legacy MG IDs and NCSG IDs.

TABLE 16
NCSG Pattern Configurations for synchronous/asynchronous
operation and mapping to legacy MG pattern IDs

| | Parameters for NCSG patterns applicable in synchronous/asynchronous network | | | | |
|---|---|---|---|---|---|
| | operation | | | | |
| | | Visible | Measurement | Visible | Visible |
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| 0 | 0 | Sync: 1 | 5 | Sync: 1 | 40 |
| | | Async: 2 | | Async: 2 | |
| 1 | 1 | Sync: 1 | 5 | Sync: 1 | 80 |
| | | Async: 2 | | Async: 2 | |
| 2 | 2 | Sync: 1 | 2 | Sync: 1 | 40 |
| | | Async: 2 | | Async: 2 | |
| 3 | 3 | Sync: 1 | 2 | Sync: 1 | 80 |
| | | Async: 2 | | Async: 2 | |
| 4 | 4 | Sync: 1 | 5 | Sync: 1 | 20 |
| | | Async: 2 | | Async: 2 | |
| 5 | 5 | Sync: 1 | 5 | Sync: 1 | 160 |
| | | Async: 2 | | Async: 2 | |
| 6 | 6 | Sync: 1 | 3 | Sync: 1 | 20 |
| | | Async: 2 | | Async: 2 | |
| 7 | 7 | Sync: 1 | 3 | Sync: 1 | 40 |
| | | Async: 2 | | Async: 2 | |
| 8 | 8 | Sync: 1 | 3 | Sync: 1 | 80 |
| | | Async: 2 | | Async: 2 | |
| 9 | 9 | Sync: 1 | 3 | Sync: 1 | 160 |
| | | Async: 2 | | Async: 2 | |
| 10 | 10 | Sync: 1 | 2 | Sync: 1 | 20 |
| | | Async: 2 | | Async: 2 | |
| 11 | 11 | Sync: 1 | 2 | Sync: 1 | 160 |
| | | Async: 2 | | Async: 2 | |
| 12 | 12 | 0.75 | 5 | 0.75 | 20 |
| 13 | 13 | 0.75 | 5 | 0.75 | 40 |
| 14 | 14 | 0.75 | 5 | 0.75 | 80 |
| 15 | 15 | 0.75 | 5 | 0.75 | 160 |
| 16 | 16 | 0.75 | 3 | 0.75 | 20 |
| 17 | 17 | 0.75 | 3 | 0.75 | 40 |
| 18 | 18 | 0.75 | 3 | 0.75 | 80 |
| 19 | 19 | 0.75 | 3 | 0.75 | 160 |
| 20 | 20 | 0.75 | 1 | 0.75 | 20 |
| 21 | 21 | 0.75 | 1 | 0.75 | 40 |
| 22 | 22 | 0.75 | 1 | 0.75 | 80 |
| 23 | 23 | 0.75 | 1 | 0.75 | 160 |

Another example of the mapping between legacy measurement gap patterns and NCSG pattern for limited number of the NCSG pattern is shown in table 17. This table mapping between the legacy MG IDs and NCSG IDs are different. But since the relation is defined therefore the UE can determine the NCSG pattern corresponding to the configured legacy pattern when transformation is done by the network e.g. by sending 1-bit transformation command.

TABLE 17
Mapping between legacy MG patterns and NCSG patterns

| | Parameters for NCSG patterns applicable in synchronous/asynchronous network | | | | |
|---|---|---|---|---|---|
| | operation | | | | |
| | | Visible | Measurement | Visible | Visible |
| | | interruption | Length during | interruption | interruption |
| Legacy | | length before | which there is | length after | Repetition |
| MG | NCSG | measurement | no gap (ML, | measurement | Period |
| pattern ID | Pattern Id | (VIL1, ms) | ms) | (VIL2, ms) | (VIRP, ms) |
| FR1: 4, | 0 | FR1 Sync: 1 | 5 | FR1 Sync: 1 | 20 |
| FR2: 12 | | FR1 Async: 2 | | FR1 Async: 2 | |
| | | FR2: 0.75 | | FR2: 0.75 | |
| FR1: 0 | 1 | FR1 Sync: 1 | 5 | FR1 Sync: 1 | 40 |
| FR2: 13 | | FR1 Async: 2 | | FR1 Async: 2 | |
| | | FR2: 0.75 | | FR2: 0.75 | |
| FR1: 1 | 2 | FR1 Sync: 1 | 5 | FR1 Sync: 1 | 80 |
| FR2: 14 | | FR1 Async: 2 | | FR1 Async: 2 | |
| | | FR2: 0.75 | | FR2: 0.75 | |
| FR1: 5 | 3 | FR1 Sync: 1 | 5 | FR1 Sync: 1 | 160 |
| FR2: 15 | | FR1 Async: 2 | | FR1 Async: 2 | |
| | | FR2: 0.75 | | FR2: 0.75 | |

In several scenarios simply transforming the currently configured legacy measurement gap pattern into NCSG pattern or vice versa, will reduce gap setup delay and reduce signaling overheads. Transformation between legacy measurement gap pattern and NCSG pattern requires mapping between legacy measurement gap pattern and NCSG pattern.

It is proposed to introduce signaling mechanism for enabling network to transform currently configured legacy measurement gap pattern to corresponding NCSG pattern and currently configured NCSG pattern to corresponding legacy measurement gap pattern. It is also proposed to introduce mapping table between legacy measurement gap patterns and corresponding NCSG patterns for the UE and gNB to determine the transform gap pattern.

It is not yet decided on NCSG Interruption requirements, but there are several options:
Option 1: The interruption requirements in TS38.133 and TS36.133 shall be revisited
Option 2: Existing interruption requirements for SCell activation/deactivation can serve as starting point for the study of VIL requirements
Option 3: the interruption is proposed as following
Option 3a: Translate 1 ms (FR1) and 0.75 ms (FR2) into the number of interrupted slots for defining the interruption requirements for the synchronous case and one more slot is added for asynchronous case.
Option 4:

VIL on active victim serving cells is the number of interrupted slots calculated based on
Aggressor reference cell RRT,
Victim cell SCS, and
Sync or async. operation

The existing measurement mode requirements, e.g., effective MGRP, data scheduling depends on gap configuration, can be the baseline.

The impact on the existing interruption requirements is minimized. Preferably there is no reason to revisit the interruption requirements defined in TS38.133 and TS36.133 when the UE measures without gaps and causes interruption on serving cells. However as compromise option 3a is supported.

NCSG patterns will also be defined as per UE and per FR. The per-UE or per-FR capability support is not decided yet, but there are several options:
Option 1:per UE and per FR NCSG for RRM measurement needs the specific UE capability.
Option 2: No additional NCSG capability for per-UE and per-FR differentiation is needed.

Regarding carrier-specific scaling factor (CCSF), only one layer can be measured for each NCSG occasion, which is the assumption for deriving CSSF.

It is reasonable to reuse the existing per FR gap UE capability for NCSG capability. This means UE indicating per FR gap capability also supports per NCSG gaps for that FR if the UE supports NCSG.

It is proposed that to translate 1 ms (FR1) and 0.75 ms(FR2) into the number of interrupted slots for defining the interruption requirements for the synchronous case and one more slot is added for asynchronous case, and per FR NCSG reuses the existing per FR UE capability.

It is not decided yet on Rx beam limitation on measurement capability when NCSG pattern is used, but there are several options:
Option 1: NCSG pattern is also supported for FR2
Option 1a. NW needs to be informed that the inter-frequency measurements with NCSG is CBM or IBM with serving cells in FR2.
Option 2: NCSG in FR2 should be deprioritized in current stage.

It is not decided on scheduling and measurement restriction yet, but there are several options:
Option 1: When NCSG is configured then during the ML the existing scheduling restriction requirements defined in TS 38.133 shall also apply,
Option 1a: To discuss if existing scheduling restrictions of TS 38.133 Section 9.2.5.3.3 for measurement on FR2 intra-frequency cell shall be extended for the use case of measurement on intra- or inter-frequency cell via NCSG instead of legacy MG.

In FR2 the UE is typically configured with large number of serving cells to support very high data rate. There is no reason to downpriortize NCSG for FR2. Whether the network needs to be informed by the UE that the inter-frequency measurements with NCSG is CBM or IBM with serving cells in FR2 can be further discussed when basic aspects of NCSG are progressed.

The existing scheduling and measurement restriction requirements defined for FR1 can be reused during ML. However, in FR2 the UE capable of Independent Beam Management (IBM) should be able to receive and transmit data during the ML.

It is proposed that NCSG pattern is also supported for FR2 i.e., NCSG is NOT down-prioritized for FR2 and the existing scheduling restriction requirements defined in TS 38.133 for FR1 shall apply during ML when serving and measured carriers are in FR1. It is also proposed that no scheduling restriction is allowed for FR2 during ML when serving carrier and measured carriers are in FR2 and use IBM.

It is not decided on necessary signaling for NCSG, but there are several options:
Option 1: Signalling supports for NCSG include at least
NCSG configuration
UE capability related to NCSG patterns and per-UE/per-FR NCSG
UE capability related to need for NCSG for a target carrier
Option 2: Deciding the signaling after NCSG pattern design as well as NCSG applicability and UE capability support are finalized

It is not decided the relation between NCSG and ‘NeedForGap’, but there are several options:
Option 1: The “NeedForGap” signaling structure can be reused for NR NCSG as a start point
Option 1a: Release-17 NCSG capability is reported on top of existing ‘NeedForGap’ signaling structure with a new component ‘NCSG’.
Option 2: Don't reuse Release-16 ‘NeedForGap’ signaling for NCSG

It is not certain if the “NeedForGap” structure can be reused or some modification is needed e.g. to add separate option of NCSG or replace ‘no gap’ with NCSG.

One important thing is that the introduction of NCSG signalling should not cause any backward compatibility problem. Therefore, NCSG is defined in a way that the existing signaling for need for gaps is maintained and is comprehensible for the legacy network. New separate signaling for NCSG is needed without any change to the current signaling structure.

Since NCSG capability signaling should not cause backward compatibility problem for legacy network not comprehending NCSG, it is proposed that the signaling aspects should be decided after NCSG pattern as well as NCSG applicability and UE capability support are finalized. It is also proposed that NeedForGap signaling structure is not reused for NCSG and the NCSG signaling details and any relation between NCSG and “NeedForGaP” should be decided later on.

In summary, further analysis of using NCSG gaps for different use cases and scenarios are provided. The scenarios for NCSG patterns are: NR UE is typically configured with one or more SCCs and the one or more SCells may often be in deactivation states to account for traffic load and/or UE power consumption. It is proposed to confirm that the NCSG is also used for the measurements on the SCC with deactivated SCell

Regarding NCSG patterns in synchronous and asynchronous operations, there is significant difference between interruption under synchronous and asynchronous operations in FR1. To avoid unnecessary interruption in synchronous operation it is more efficient to use NCSG pattern specific to synchronous operation in FR1. It is proposed that the NCSG pattern depends on FR, wherein different NCSG patterns are used for synchronous and asynchronous operations in FR1 and same NCSG patterns are for synchronous and asynchronous operations in FR2. It is also proposed to define selected NCSG patterns with lager MGL, e.g., 5.5 ms-6 ms, and to define NCSG patterns for synchronous and asynchronous operations corresponding to legacy gap patterns with ID #0, #1, #13 and #14.

Regarding configuration parameters of NCSG patterns, it is proposed that VIL1 and VIL2 for FR1 and FR2 are defined agnostic to SCS to limit the NCSG patterns, and VIL1 and VIL2 for FR1 and FR2 are defined as follows:

| | |
|---|---|
| VIL1 | VIL2 |

| FR | Sync | Async | Sync | Async |
|---|---|---|---|---|
| FR1 | 1 ms | 2 ms | 1 ms | 2 ms |

| | | |
|---|---|---|
| FR2 | 0.75 ms | 0.75 ms |

It is also proposed that the ML should be sufficiently long enough to contain SMTC window and the ML is defined as follows:

$$ML = Legacy MGL - 2 * RRT$$

$$Where : RRT = 0.5 ms for FR 1 and 0.25 ms for FR 2$$

Regarding NCSG configuration mechanism, in several scenarios simply transforming the currently configured legacy measurement gap pattern into NCSG pattern or vice versa, will reduce gap setup delay and reduce signaling overheads. Transformation between legacy measurement gap pattern and NCSG pattern requires mapping between legacy measurement gap pattern and NCSG pattern. It is proposed to introduce signaling mechanism for enabling network to transform currently configured legacy measurement gap pattern to corresponding NCSG pattern and currently configured NCSG pattern to corresponding legacy measurement gap pattern. It is also proposed to introduce mapping table between legacy measurement gap patterns and corresponding NCSG patterns for the UE and the gNB to determine the transform gap pattern.

Regarding impact on RRM requirements due to NCSG, it is proposed to translate 1 ms (FR1) and 0.75 ms (FR2) into the number of interrupted slots for defining the interruption requirements for the synchronous case and one more slot is added for asynchronous case. It is also proposed that Per FR NCSG reuses the existing per FR UE capability.

Regarding measurement applicability, it is proposed that NCSG pattern is also supported for FR2 i.e., NCSG is NOT downprioritized for FR2 and the existing scheduling restriction requirements defined in TS 38.133 for FR1 shall apply during ML when serving and measured carriers are in FR1. It is also proposed that no scheduling restriction is allowed for FR2 during ML when serving carrier and measured carriers are in FR2 and use IBM.

Regarding signaling aspects, the NCSG capability signaling should not cause backward compatibility problem for legacy network not comprehending NCSG. It is proposed that signaling aspects should be decided after NCSG pattern design as well as NCSG applicability and UE capability support are finalized. It is also proposed that NeedForGap signaling structure is not reused for NCSG and the NCSG signaling details and any relation between NCSG and “NeedForGap” should be decided later on.

1. A method performed in a User Equipment (UE) in a New Radio (NR) network, comprising:
reporting to a network node, a capability indicating whether the UE supports Network Controlled Small Gap (NCSG) using a bit indicator together with Measurement Gap (MG) patterns supported by the UE; or reporting, to the network node, NCSG patterns supported by the UE or one or more mandatory NCSG patterns supported by the UE using a number of bits;
receiving a request message from the network node for performing a transformation from a current configured MG pattern to a corresponding NCSG pattern or from a current configured NCSG pattern to a corresponding MG pattern;
determining parameters of the corresponding NCSG pattern or the corresponding MG pattern based on a mapping rule between MG patterns and NCSG patterns or from indication information received from the network node, wherein the MG patterns of the mapping rule include the MG patterns supported by the UE and the NCSG patterns of the mapping rule include the NCSG patterns supported by the UE; and
switching to the corresponding NCSG pattern or the corresponding MG pattern for performing a measurement.

2. The method of claim 1, further comprising:
receiving the indication information from the network node for indicating which one of the MG patterns or which one of the NCSG patterns supported by the UE is to be used.

3. The method of claim 1, further comprising:
receiving, from the network node, the indication information comprising configuration information of the corresponding NCSG pattern or configuration information of the corresponding MG pattern.

4. The method of claim 1, wherein the switching comprises:
switching to the corresponding NCSG pattern or the corresponding MG pattern within a transition time (ΔT) after the UE received the request message for transformation from the network node.

5. The method of claim 1, wherein the mapping rule is defined to guarantee a Measurement Length (ML) of each NCSG pattern equal to an effective Measurement Gap Length (MGL) of each corresponding MG pattern.

6. The method of claim 5, wherein the mapping rule is defined by 1-to-1 mapping each NCSG pattern to each MG pattern with a same or corresponding gap index, and wherein a Visible Interruption Repetition Period (VIRP) of each NCSG pattern has a same value as a Measurement Gap Repetition Period (MGRP) of each MG pattern with the same or corresponding gap index.

7. The method of claim 5, wherein the mapping rule is defined where the NCSG patterns supported by the UE are a subset of the MG patterns supported by the UE.

8. The method of claim 7, wherein the mapping rule is defined by mapping one or more parameters of the MG pattern to one or more parameters of the corresponding NCSG pattern by a function.

9. The method of claim 8, wherein the function comprises MGL/(VIl1+VIL2)>threshold, where MGL represents a measurement gap length of the MG pattern, VIL1 represents a Visible Interruption Length (VIL) before measurement, and VIL2 represents a VIL after measurement which is different from VIL1 or the same as VIL1.

10. The method of claim 7, wherein the NCSG patterns supported by the UE correspond to mandatory MG patterns in the MG patterns supported by the UE.

11. The method of claim 1, wherein the one or more mandatory NCSG patterns are determined based on at least one of following criterions:
Mandatory NCSG patterns are the patterns with the same effective Measurement Gap Length (MGL) as in mandatory MG patterns;
Mandatory NCSG patterns are the patterns with the same effective MGL as a sub-set of mandatory MG patterns;
Mandatory NCSG patterns are the patterns whose Measurement Length ML and (VIL1+VIL2) are related by a function, wherein VIL1 represents a Visible Interruption Length (VIL) before measurement, and VIL2 represents a VIL after measurement which is different from VIL1 or the same as VIL1; and
Mandatory NCSG patterns are the patterns that the MGL of MG pattern and (VIL1+VIL2) are related by a function.

12. The method of claim 11, wherein ML/(VIL1+VIL2)>threshold T1; or MGL/(VIL1+VIL2)>threshold T2.

13. The method of claim 5, further comprising:
determining a NCSG timing advance (NGTA) to guarantee the ML in the NCSG pattern aligned with the effective MGL in MG pattern.

14. The method of claim 5, further comprising:
determining a NCSG timing advance (NGTA) to guarantee the ML contain the Synchronization Signal/Physical Broadcast Channel block Measurement Timing Configuration (SMTC) window.

15. The method of claim 13, wherein the NGTA is determined based on the NCSG pattern and Measurement Gap Timing Advance (MGTA) configured for the MG pattern.

16. The method of claim 13, further comprising:
determining one common Timing Advance for both the NCSG pattern and the MG pattern based on a function of NGTA and MGTA when the UE is configured with both the NCSG pattern and the MG pattern and also with MGTA for the MG pattern and NGTA for the NCSG pattern.

17. The method of claim 5, wherein the effective MGL of the MG pattern equals to the MGL minus twice the switching time, wherein the switching time being used for the UE switching from a carrier of a serving cell to a carrier of a measured cell.

18. A method performed in a network node in New Radio (NR) network, comprising:
receiving, from a User Equipment (UE), a capability information of the UE indicating whether the UE supports Network Controlled Small Gap (NCSG) using a bit indicator together with Measurement Gap (MG) patterns supported by the UE; or reporting, to the network node, NCSG patterns supported by the UE or one or more mandatory NCSG patterns supported by the UE using a number of bits; and
transmitting a request message to the UE for transforming from a current configured MG pattern to a corresponding NCSG pattern or for transforming from a current configured NCSG pattern to a corresponding MG pattern.

19. The method of claim 18, further comprising:
sending an indication information to the UE for indicating which one of the MG patterns or which one of the NCSG patterns supported by the UE is to be used.

20. The method of claim 18, further comprising:
sending, to the UE, an indication information comprising configuration information of the corresponding NCSG pattern or configuration information of the corresponding MG pattern, obtained from a mapping rule between MG patterns and NCSG patterns.

21-27. (canceled)
